(19) United States
(12) Patent Application Publication
(10) Pub. No.: US 2013/0307781 A1
(43) Pub. Date: Nov. 21, 2013

(54) DATA ENTRY SYSTEMS

(71) Applicant: Benjamin Firooz Ghassabian, Jerusalem (IL)

(72) Inventor: Benjamin Firooz Ghassabian, Jerusalem (IL)

(73) Assignee: Keyless Systems, Ltd., Jerusalem (IL)

(21) Appl. No.: 13/981,917

(22) PCT Filed: Jan. 26, 2012
(86) PCT No.: PCT/IL12/00048

§ 371 Date: Jul. 26, 2013

Related U.S. Application Data
(60) Provisional application No. 61/556,389, filed on Nov. 7, 2011.

(51) Int. Cl. G06F 3/0487

(52) U.S. Cl. CPC G06F 3/0487
USPC 345/168

(57) ABSTRACT

A data entry system having a plurality of keys to which substantially all of the letters of an alphabet are assigned based on their common characteristics in their shapes. The letters are divided in a plurality of groups of letters based on the characteristics. In order to enter a word the user interacts with the appropriate keys. A word predictive system predicts the desired word based on the key interactions.

### RELATED APPLICATIONS

The present application claims priority from Israeli patent applications:

| | | |
|---|---|---|
| 210,894 | filed | 26 Jan. 2011 |
| 210,981 | filed | 31 Jan. 2011 |
| 211,102 | filed | 06 Feb. 2011 |
| 211,338 | filed | 21 Feb. 2011 |
| 211,798 | filed | 17 Mar. 2011 |
| 211,887 | filed | 23 Mar. 2011 |
| 211,962 | filed | 27 Mar. 2011 |
| 212,281 | filed | 12 Apr. 2011 |
| 212,430 | filed | 17 Apr. 2011 |
| 212,478 | filed | 26 Apr. 2011 |
| 212,617 | filed | 01 May 2011 |
| 212,661 | filed | 03 May 2011 |
| 212,681 | filed | 04 May 2011 |
| 212,831 | filed | 11 May 2011 |
| 213,021 | filed | 19 May 2011 |
| 213,046 | filed | 22 May 2011 |
| 213,333 | filed | 02 Jun. 2011 |
| 213,641 | filed | 19 Jun. 2011 |
| 213,914 | filed | 03 Jul. 2011 |
| 214,104 | filed | 14 Jul. 2011 |
| 214,471 | filed | 04 Aug. 2011 |
| 214,494 | filed | 07 Aug. 2011 |
| 214,581 | filed | 10 Aug. 2011 |
| 214,737 | filed | 18 Aug. 2011 |
| 215,087 | filed | 11 Sep. 2011 |
| 215,223 | filed | 18 Sep. 2011 |
| 215,446 | filed | 27 Sep. 2011 |
| 215,605 | filed | 06 Oct. 2011 |
| 215,718 | filed | 11 Oct. 2011 |
| 216,020 | filed | 27 Oct. 2011 |
| 216,045 | filed | 30 Oct. 2011 |
| 216,170 | filed | 07 Nov. 2011 |

and claims the benefit, under 35 USC 119(e), of US provisional application

| | | |
|---|---|---|
| USSN 61/556,389 | filed | 07 Nov. 2011 |
| USSN 61/560,883 | filed | 17 Nov. 2011 |
| USSN 61/562,691 | filed | 22 Nov. 2011 |
| USSN 61/577,041 | filed | 18 Dec. 2011 |
| USSN 61/582,427 | filed | 02 Jan. 2012 |
| USSN 61/584,376 | filed | 09 Jan. 2012 |

the disclosures of which are all incorporated herein by reference in their entirety.

This application is also related to various prior PCT publication, including WO01/131788, titled “Integrated Keypad System”, WO03/007288 titled “Features to Enhance Data Entry Through a Small Data Entry Unit”, WO04/095414 titled “System to Enhance Data Entry in Mobile and fixed Environment”, WO05/122401 titled “System to Enhance Data Entry in Mobile and fixed Environment”, WO07/114,833 titled “Data Entry System”, WO08/114,086 titled “Combined Data Entry Systems”, WO09/027,817 titled “Improved Data Entry System”, WO10/018,577 titled “Data Entry System”, WO10/089,740 titled “Data Entry System”, and WO11/073,992 titled “Features of a data entry system”, the disclosures of all of which are also incorporated herein, by reference, in their entirety.

The titles used in this application and in the related applications may preferably not been considered as part of the descriptions.

### FIELD OF THE INVENTION

The present invention relates to data input devices and particularly to devices and methods for entering letters and other symbols.

### BACKGROUND OF THE INVENTION

Mobile devices including cellular phones, personal digital aids and miniature computers are widely used as they are easily carried around and can perform many tasks. One problem of the mobile devices is text entry, which is problematic due to their small size. One solution for text entry in mobile devices is using a limited key set in which at least some of the keys are ambiguously associated with a plurality of letters. Upon receiving a sequence of key strokes, a word predictive system proposes a word of a dictionary/database. If the system dos not propose the correct word, the system proposes other words. The problem of such system is that when a word is not in the database the user must use another method of text entry.

Another problem of mobile devices is entering symbols other than letters.

With the emergence of devices having touch screens, on screen full (e.g. QWERTY) keyboard systems are used on most devices. Due to the size of mobile devices, and the number of keys of a full keyboard, such keys are reduces in size rendering the keyboard cumbersome and the data entry slow. Such keyboard is not adapted to be on a screen. The screen of a device, is intended to display the output. Having a full keyboard with many keys on the screen covers a significant portion of the screen, hindering the use of many current applications and limiting creation of many other applications.

A real mobile data entry system must be mobile, enabling to enter data in any environment such as while standing, walking, in the dark, etc. In addition, such system must preferably free the screen from an interface that occupies a large portion of the screen.

### SUMMARY OF THE INVENTION

The data entry system described in this application, provides a system that is adapted to mobile environments. It is also intuitive, accurate, fast, and easy to understand and use.

An aspect of some embodiments of the invention relates to an input interface adapted to identify user interactions and to associate at least some of the user interactions with characters. A small number of the user interactions are associated ambiguously with all the letters of the Latin alphabet or another alphabet. The letters are assigned to the user interactions according to their shapes, in a manner which allows the user to quickly translate the shape of a letter to the interaction with which it is associated. In some embodiments, one of the user interactions is associated with all the letters meeting a specific shape feature.

Optionally, the letters are divided into several groups (e.g. four groups) based on a common characteristic in their shapes and wherein each group is assigned to a different user's interaction or to a different key of a keypad.

In some embodiments, the letters are assigned to the user interactions/keys according to whether they have a closed circle, standing on one point, standing on two points, or standing on a large base.

Optionally, a single letter may be assigned to two different groups.

An aspect of some embodiments of the invention relates to an input interface having a plurality of input means (e.g. keys) such as four input means to which altogether substantially all of the letters of a language are assigned. Preferably, the input interface further includes additional input means relating to at least one symbol (e.g. letter, special character, function, etc.) such as the space character and the back space function. Optionally, each of, the space character and the backspace function, is assigned to a different input means. Optionally, to at least one of the input means more than a letter of a language is assigned such that a predefined interaction with the input means ambiguously corresponds to any of said letters.

Optionally, to each of at least some of the input means a group of special characters and/or functions are assigned. Preferably, special characters are divided into a plurality of groups (e.g. four groups) based on a common characteristic.

Optionally, each of the groups of special characters is assigned to one of the input means to which the letters are (e.g. ambiguously) assigned.

An aspect of some embodiments of the invention relates to an input system wherein a first predefined type of interaction with an input means ambiguously correspond to any of a first group of characters assigned to said input means, and wherein a second predefined type of interaction with the input means ambiguously correspond to any of a second group of characters assigned to said input means,

An aspect of some embodiments of the invention relates to an input system wherein a first predefined type of interaction with an input means ambiguously correspond to any of a group of characters assigned to said input means, and wherein a second predefined type of interaction with an input means (precisely) correspond to an identified character assigned to said input means.

An aspect of some embodiments of the invention relates to a data entry system using a database of words to predict one or more words based the user's interactions with the input means.

An aspect of some embodiments of the invention relate to a data entry system having a correction procedure to enter precisely one of the characters assigned to an input means (e.g. hereafter, referred to as an “identified character/letter”).

An aspect of some embodiments of the invention relate to a procedure of accepting or rejecting a word proposed/predicted by the system. Optionally, if the predicted word is rejected the system proposes at least another word. Optionally, the system enters into the Correction Mode, wherein a predefined interaction with an input means corresponds to correcting one or more of the letters of the predicted word.

An aspect of some embodiments of the invention relates to a data entry system using one or more N-gram database of words to predict a word.

An aspect of some embodiments of the invention relates to a data entry system using precise letter(s) and input.

An aspect of some embodiments of the invention relates to a calibration procedure so that to permit the user to type anywhere on a touch sensitive surface.

An aspect of some embodiments relates to using database(s) having compound words in its entries. A compound word is a sequence of words being connected to each other by a connector. A compound word is considered by the system/user as a single word/unit.

### BRIEF DESCRIPTION OF FIGURES

Exemplary non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 100 is a schematic illustration of arrangement of the letters of a language, in accordance with an exemplary embodiment of the invention;

FIG. 101 is a schematic illustration of a mobile device having a touch screen, and the keys of the data entry system in predictive mode, in accordance with an exemplary embodiment of the invention;

FIG. 101A is a schematic illustration of keys of the data entry system and a manner of entering precise/identified letters when the system is in Letter Mode, in accordance with an exemplary embodiment of the invention;

FIG. 101B is a schematic illustration of keys of the data entry system and a manner of entering precise/identified special characters when the system is in Special Character Mode, in accordance with an exemplary embodiment of the invention;

FIGS. 101C-D are schematic illustrations of keys of the data entry system and a manner of entering precise/identified character when the system is in Precise Letter/Special Character Modes, in accordance with an exemplary embodiment of the invention;

FIG. 102 are schematic illustrations of the keys of the invention when they are pressed for a predefined laps of time, in accordance with an exemplary embodiment of the invention;

FIG. 103 is a schematic illustration of the keys of the data entry system in Invisible Mode, in accordance with an exemplary embodiment of the invention;

FIGS. 320A-320B are schematic illustrations of the entry of derivatives of a character, in accordance with an exemplary embodiment of the invention.

FIGS. 336A-336D are schematic illustrations of the entry of words using an N-gram database, in accordance with an exemplary embodiment of the invention.

FIGS. 337A-337D are schematic illustrations of the entry of words including special characters, in accordance with an exemplary embodiment of the invention;

FIG. 340 is a schematic illustration of distribution of Korean letter in four group of letters based on the common characteristics in their shapes, in accordance with an exemplary embodiment of the invention;

FIGS. 365A-365B are schematic illustrations of a gesture based data entry system, in accordance with an exemplary embodiment of the invention;

FIGS. 365C-365D are schematic illustrations of the data entry system of the invention used in a vehicle, in accordance with an exemplary embodiment of the invention;

FIG. 366 is a schematic illustration of distribution of a gesture based data entry system, in accordance with an exemplary embodiment of the invention.

FIG. 367 is schematic illustration of a social entertainment interface using the invisible input interface of the system, in accordance with some exemplary embodiments of the invention.

FIGS. 370A-371B are schematic illustrations of the entry of prediction/presentation of word candidates, in accordance with some exemplary embodiments of the invention.

FIG. 373 is schematic illustration of key(s) having a round shape, in accordance with some exemplary embodiments of the invention.

FIG. 375 is schematic illustration of six group of letters grouped based on their common shape characteristics, in accordance with some exemplary embodiments of the invention.

### DETAILED DESCRIPTION OF EMBODIMENTS

The data entry system of the invention uses a predefined number of keys to enter text. The letters/characters of a language are distributed on at least some of said number of input means (e.g. hereafter may be referred to as “keys”) such that to at least one of the keys (e.g. hereafter referred may be referred to as a “letter key” or “ambiguous key”) more than one letter/character is assigned.

### The Preferred Keypad

According to one embodiment of the invention, a keypad of the invention (e.g. hereafter may be referred to as “the first keypad”) may preferably include four letter keys. The keypad may preferably include at least one of, a space keys and a backspace key. Preferably, the letter keys are arranged such that to form two columns of letter keys. Preferably, the space key is positioned on the side of a first column of letter keys and the backspace key is positioned on the side of a second column of letter keys. Optionally, each of said space or the backspace keys may form a column of keys together a first and a second column of letter keys, respectively.

### Common Shapes

According to a one embodiment of the invention, the letters of a language may be divided into several groups based on a common characteristic in their shape. Preferably, the letter of each group have a common characteristic in their shape.

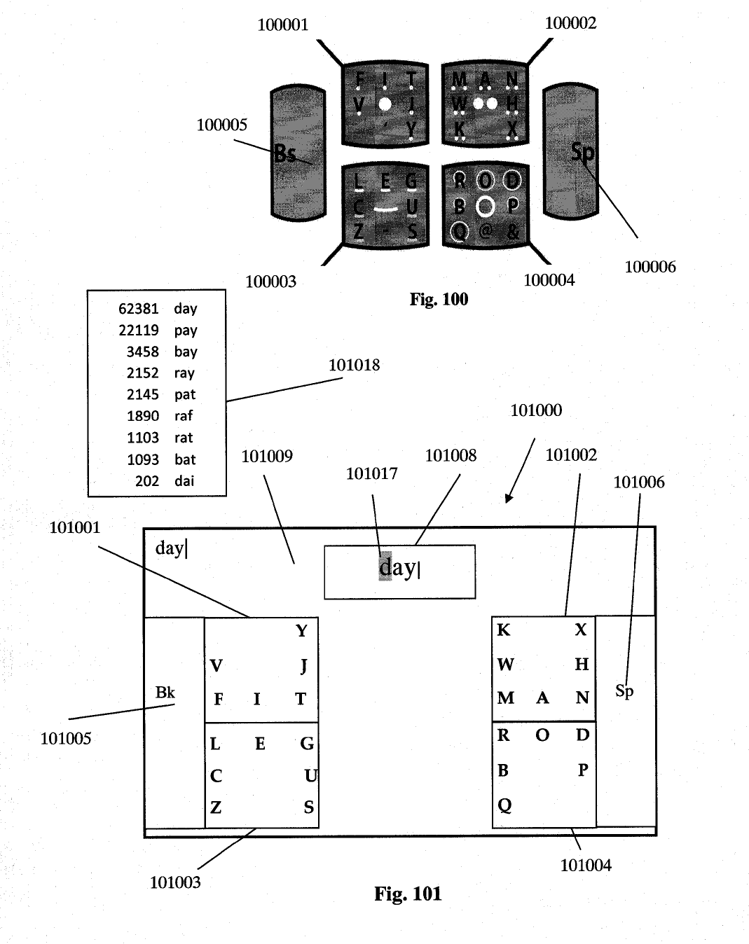

According to one embodiment, as shown in FIG. 100, a preferred type of distribution of the letters (e.g. of Roman/English alphabet) on the keys of the first keypad based on their common (partial) shape characteristics as described before may be considered. In this embodiment, the letters of the alphabet are divided into four groups based on their common shapes (characteristics) wherein each group is assigned to a different key of the keypad of the invention. One of the groups (e.g. a first group) generally includes the letters that have a substantially closed circle in their shape. In this example, they are assigned to the key 100004 of the first keypad. One of the groups (e.g. a second group) generally includes the letters that if they were objects standing on a plane/flat surface they would have two touching points with said surface (e.g. or in other words they have two legs). In this example, they are assigned to the key 100002 of the first keypad. One of the groups (e.g. a third group) generally includes the letters that if they were objects standing on a plane surface they would have one touching point with said surface. In this example, they are assigned to the key 100001 of the first keypad. One of the groups (e.g. a fourth group) generally includes the letters that have a straight and/or a curved lined base (e.g. in other words, they are standing on a large base). In this example, they are assigned to the key 100003 of the first keypad. The common portions (e.g. shape) characteristics are also shown on/under each letter on its corresponding key.

According to one method, the distribution of letters among groups may take in account that a common shape characteristic of one of the groups of letters may have priority over the common characteristic(s) of at least some of the other groups. For example, the first group may have priority over the other groups. In consequence, the letter “R” (e.g. having a closed circle, and standing on two legs) which could have been included in both, the first and the second group, is assigned to the first group which has priority over the other groups (i.e. in this example the “closed circle” group has a priority over the “two legs” group). In this example, the first keypad also includes a space key 100006 and a backspace key 100005 as shown in FIG. 100.

As described before, the letters of a language may be grouped in four groups based on a common characteristic in their shape. Hereafter together they are called “original groups of letters” such as the following, for example:

Group 1: comprises letters that include a substantially closed circle in their shape (e.g., B, D, O, P, Q, R). According to one embodiment, this common shape has, preferably, higher priority over the other common shapes. Other letters, which may be divided into other common shapes, are divided in the following groups:
Group 2: letters that stand on one point: (e.g., F, I, J, T, V, Y)
Group 3: letters that stand on two points: (e.g., A, H, K, M, N, W, X)
Group 4: letters that stand on a wide base (e.g., C, E, G, L, S, U, Z)

As mentioned before, each of the above group(s) of character(s) may be assigned to a different input means (e.g. to a different key).

In the arrangement above, some letters such as for example “R”, and “P” may be confusing for a user, for example in classifying which group applies to each of the example's letter. For example, it may happen that a user may get confused and, for example, in order to enter the letter “R”, the user may erroneously press the key corresponding to the letters that stand on two points (e.g. letter “R” has, both characteristics, it has a closed circle in its shape, and also stands on two points). To resolve such problems, according to one embodiment of the invention, confusing letters may be assigned to more than one group of characters. As such, as an example, the four following “enlarged groups of letters” may be considered by the system:

Group 1: comprises letters that include a substantially closed circle in their shape (e.g., B, D, O, P, Q, R). According to one embodiment, this common shape has preferably higher priority over the other common shapes. Other letters, which may be divided into other common shapes, are divided in the following groups:
Group 2: letters that stand on one point: (e.g., F, I, J, T, V, Y, and P)
Group 3: letters that stand on two points: (e.g., A, H, K, M, N, W, X, and R)
Group 4: letters that stand on a wide base (e.g., C, E, G, L, S, U, Z, and J)
Some of the letters of a group may be considered as the second degree letters in their respective groups. In the example of the enlarged groups of letters, each of the letters “P, R, and J”, may be considered as the second degree letter in its respective group of letters.

### Split Keypad

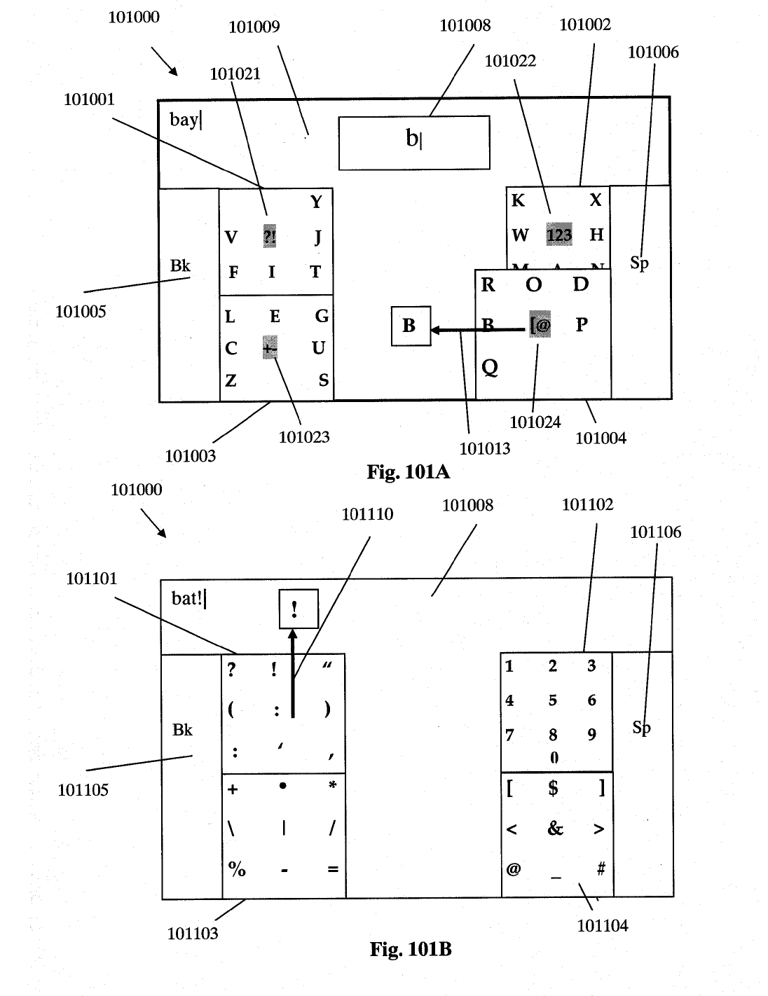

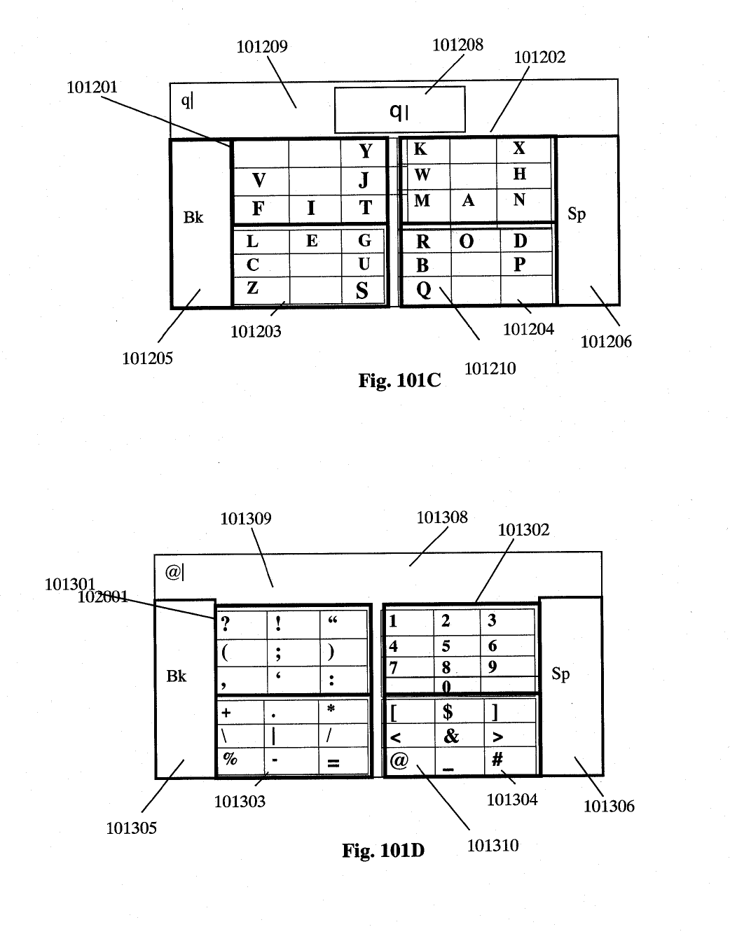

According to one embodiment, as shown in FIG. 101, the first keypad may be split into two portions wherein the first portion includes two of the letter keys 101001,101003, and the second portion includes two of the letter keys 101002,101004. Preferably, substantially all of the letters of a language are assigned to four of the keys (e.g. 101001-101004) of the keypad. As mentioned, the keypad may preferably also include a space key 101006, and a backspace key 101005. Preferably, the letter keys (e.g. 101001-101004) are arranged such that to form two columns of letter keys. Preferably, the space key 101006 is positioned on the side of a first column of letter keys 101002, 101004, and the backspace key is positioned on the side of a second column 101001, 101003, of letter keys. Optionally, each of said space or the backspace keys may form a column of keys together a first and a second column of letter keys, respectively.

### Text Entry

According to one embodiment, a word predictive system using a database of words may be used by the data entry system of the invention. Upon interaction(s) (e.g. tapping action(s)) with the one or more keys, the system may predict a word from the database and preferably propose it to a user.

As an example, FIG. 101 shows a device having a touch sensitive surface 101009, and the data entry system of the invention. By considering the portion 101018 of a 1-gram database used by the system, in order to enter the word “day” the user may provide input information corresponding to entering said word by for example pressing/tapping actions on ambiguous keys 101004, 101002, 101001 (e.g. such key pressing actions may provide a key press value 421 for search purpose). The system may propose/predict the word “day” which corresponds to said key presses and has the highest priority among the words of the database corresponding to said key pressing actions. If the predicted word is the desired word, the user may confirm it by providing an end-of-the-word signal such as tapping on the space key. As such, according to one method, in addition to entering the predicted word, the system may provide a space character after the entered word.

According to one method, one of the characters, preferably the current predicted word (e.g. hereafter may be referred to as the “current word”) is (e.g. also) shown in a separate window 101008 in the text/on the screen. Preferably, the first character/character position of a current predicted word may be selected/highlighted by the system. Optionally, the user may also be able to select a character of the current word. Preferably, the selected character may be highlighted. As an example, the user may slide his finger on said window/word towards left or right to select another character on the right side or left side of the selected character. The system then may highlight the new selected character. According to one method, each consecutive sliding action in a same direction selects the next character of the predicted word in said direction, while according to another method, the length of a single sliding action in a direction defined the character to be selected in said direction.

In accordance with one method, the word suggested/proposed is the word having the highest priority among the words corresponding to the input information.

### Correction

If the proposed word is not the desired word, the user may proceed with what is referred to herein as a correction procedure by providing additional input information relating to the desired word. As an example, the user may provide additional information (e.g. speaking the appellation of the desired character) relating to one of the characters, preferably, the first and/or the selected/highlighted character (position) of the desired word to help the system to identify the desired character in said character position. The system preferably relates the additional input information to the selected/highlighted position of the current predicted word. Preferably, the user may provide an identified/precise character of the desired word (e.g. the additional information) through another type of interaction. By combining the original input information and the additional information the system may predict a (e.g. another) word of the corresponding group of word of the database (e.g. the system looks for words corresponding to the key presses provided by the user and beginning with the identified letter).

In the example of FIG. 101A, after the system proposes the word “day”, the user may proceed to the correction procedure of the invention and provide a gliding action 101013 on/from the key 101004 corresponding to the letter “b” to enter precisely the first character of the desired word. By considering said character and the key press information corresponding to the remaining characters of the desired word provided through the first keypad the system may propose/predict a new word “bay” which corresponds to the combined information provided by the user and has the highest priority among the words of the portion 101018 of the database, corresponding to said combined information. Preferably, the system may automatically select/highlight the next (e.g. ambiguous) character of the predicted word.

With continuous description of the current embodiment, if the new word is still not the desired word, the user may provide the next precise character of the desired word to identify the selected/highlighted character. For example, the user may enter precisely the second letter of the desired word “a” by any means such as by providing a gliding action (not shown) relating to the letter “a” from/on the key 101002. The system may propose another new word corresponding to the combined input information provided until then (Note that according to one embodiment, the selected/highlighted (e.g. ambiguous character) and the desired identified character may be the same). In this example, the word “bat” may be predicted/proposed by the system. Preferably, the system may automatically select/highlight the next (e.g. ambiguous) character of the predicted word.

If the new predicted word is still not the desired word, the user may provide precisely the subsequent character(s) of the desired word (e.g. relating to the selected/highlighted position(s) until the system proposes/predict the desired word.

### Symbols Such as Special Characters and Functions

Optionally, to each of the keys of the first keypad a group of special symbols such as special character and/or functions may be assigned.

Symbols such as special characters, commands, and functions, of PC keyboard and/or customized functions, may be grouped in different categories based on their common characteristics (e.g. digits 0-9, punctuation marks, arithmetic characters, PC commands, etc.). Each of said groups of symbols may be assigned to one of the keys of the first keypad.

FIG. 101A shows as an example, the first keypad 101000 having four letter keys 101001-101004. In this example, the special symbols used with the data entry system are divide in four groups based on their common characteristics:
1. A first group generally includes the punctuation mark characters;
2. A second group generally includes the digits 0-9;
3. A third group generally includes arithmetic characters;
4. A fourth group generally includes at least some of the other special characters and/or rarely used characters.
   According to one embodiment, each of said groups is assigned to one of the keys 101001-101004 of the first keypad. In this example, the appellation/icons of each group is printed on the center 101021-101024 of each corresponding key 101001-101004, respectively.

Some special characters such as dot “.” may belong to more than one groups of characters.

Preferably, the system may be designed such that to support the entry of words including letter and/or special characters. According to one embodiment, the word predictive system supports ambiguous special characters (too).

According to one embodiment, a predefined interaction such as a tapping action on an ambiguous key may preferably ambiguously correspond to any character of mainly a group of letter, and/or special characters assigned to said key.

According to one embodiment, a predefined interaction such as a press-hold-and-releasing action with an ambiguous key may preferably ambiguously correspond to any character of a group of special characters assigned to said key.

According to one embodiment, a first predefined interaction such as a tapping action with an ambiguous key may preferably ambiguously correspond to any character of a mainly group of letter, and/or special characters assigned to said key, and a second predefined interaction such as a press-hold-and-releasing action with an ambiguous key may preferably ambiguously correspond to any character of a group of special characters assigned to said key.

### Modes

The system may include a plurality of mode states/instances. Depending on the mode state, the keypad of the invention may change its appearance.

1. Predictive/Ambiguous Letter Mode

Preferably, by default, the system is in the predictive mode wherein a predefined interaction such as a tapping action on a key may preferably ambiguously correspond to (e.g. entering) any of a group of characters assigned to said key. An example of the input interface in this mode is shown in FIG. 101.

2. Predictive/Ambiguous Special Character Mode

Preferably, when a user presses and holds a (letter) key for a predefined laps of time, the system may enter into a predictive special character mode. According to one method, if the user removes his finger from the key without providing a gliding action, said interaction may preferably ambiguously correspond to (e.g. entering) any of a group of characters assigned to said key.

Precise Letter Mode (e.g. Activated from an Ambiguous Key)

When a user touches a letter key in the predictive mode instance, and begins to provide a predefined gliding action on said letter key, the system may enter into a precise letter mode instance, wherein after terminating the gliding action, the system enters an identified character relating to said gliding action. According to a first method, the key appearance in this mode may not change. According to a second method, in this mode, the key may be enlarged. According to one method, when a user provides a gliding action on a key, said key is enlarged. Preferably, when a user touches a key to provide a gliding action, a copy of said (e.g. original) key may be located under the user's finger wherein the center of said key is located at the user's touching point. By doing so, the direction of the gliding action from a touching point towards a predefined letter on a key remains the same regardless of the user's finger touching point on the (e.g. original) key. To enter precisely a character that is assigned to the center key/zone, a predefined interaction such as a short gliding action or a back-and-froth gliding action (from the touching point) may be provided. An example of the input interface is shown in FIG. 101A, gliding wherein (beginning provide) a gliding action 101013 enters a system into this mode.

3. Precise Special Character Mode (e.g. Activated from an Ambiguous Key)

When a user presses and holds a (letter) key for a predefined laps of time, the system may enter into a predictive special character mode. If the user begins to provide a predefined gliding action on said key, the system may enter into a precise Special Character Mode instance, wherein after terminating the gliding action, the system enters an identified special character relating to said gliding action. According to a first method, the key appearance in this mode may not change. According to a second method, in this mode, the key may be enlarged. According to one method, when a user provides a gliding action on a key, said key is enlarged. Preferably, when a user touches a key to provide a gliding action, a copy of said (e.g. original) key may be located under the user's finger wherein the center of said key is located at the user's touching point. By doing so, the direction of the gliding action from a touching point towards a predefined special character on a key remains the same regardless of the user's finger touching point on the (e.g. original) key. To enter precisely a character that is assigned to the center key/zone, a predefined interaction such as a short gliding action or a back-and-froth gliding action (from the touching point) may be provided. An example of the input interface in this mode is shown in FIG. 101B, wherein providing a press-and-holding action and providing (e.g. beginning to provide) a gliding action 101110 enters a system into this mode.

4. Precise Letter Mode Using Second Keypad(s) Having Specific Zones

Each of the keys of the predictive keypad may be replaced by a corresponding plurality of specific zones/keys, referred to as a second keypad of the invention. Each of at least some of said zones may represent an identified character, preferably a letter. A predefined action such as a tapping action on a specific zone/key of a second keypad may enter an appropriate character/letter precisely.

A first predefined user's interaction such as a gliding action in a first direction on the backspace key, or a predefined response of the system to a user's input information/interaction (e.g. during the entry of a word) may activate this mode. An example of the input interface in this mode is shown in FIG. 101C. In this example, each of the ambiguous keys of the first keypad is replaced by a corresponding second keypad of the invention. For example, a tapping action on a zone/key 101210 of the second keypad 101204 may correspond to entering the letter “Q”.

5. Precise Special Character Mode Using Second Keypad(s) Having Specific Zones

Each of the keys of the predictive keypad may be replaced by a corresponding plurality of specific zones/keys referred to as a second keypad of the invention. Each of at least some of said zones may represent an identified character, preferably a special character/function. An example of the input interface in this mode is shown in FIG. 101D. A predefined action such as a tapping action on a specific zone/key of a second keypad may enter an appropriate special character/function precisely.

A second predefined user's interaction such as a gliding action in a second direction on the backspace key, or a predefined response of the system to a user's input information/interaction (e.g. during the entry of a word) may activate this mode. In this example, each of the ambiguous keys of the first keypad is replaced by a corresponding second keypad of the invention. For example, a tapping action on a zone/key 101310 of the second keypad 101304 may correspond to entering the character “@”.

According to one embodiment, when the system or a key of the first keypad enters into the special character mode, the system preferably shows a corresponding second keypad of the invention, for at least said key or for all of the keys of the first keypad (e.g. by replacing said key, or all of the keys of the first keypad).

### Common Special Characters and Commands

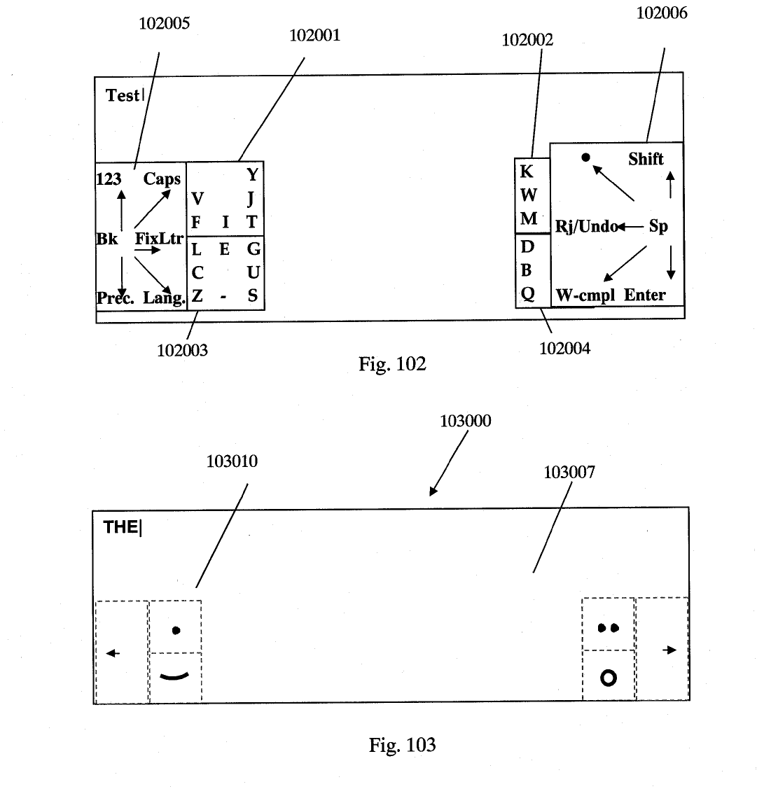

Some frequently used Special Characters and Commands may be assigned to interactions such as taping or gliding action in different (predefined) directions on or from the keys (preferably other than the letter keys) of preferably the first keypad. As described for the letter keys, preferably when a user touches a key (e.g. 102006 of FIG. 102) other than the letter keys, said key may be enlarged and centered under the user's finger.

FIG. 102 shows as an example, a device having the first keypad of the invention having four letter keys, and two additional keys 102005 and 102006, to which some frequently used characters and commands are assigned. As an example, on the Backspace Key:
1. A pressing action anywhere on the key 102005 may correspond to the backspace (“Bk”) function.
2. A gliding action departing anywhere from said key upward may correspond to entering the system into the Precise Special Character mode.
3. A gliding action departing anywhere from said key downward may correspond to entering the system into the Precise Letter mode.
4. A gliding action departing anywhere from said key towards upper-right side may correspond to the CapsLock function.
5. A gliding action departing anywhere from said key towards lower-right side may correspond to a procedure of replacing the current database by another database. One type of said databases are the databases of words in different languages. According to one method, after the user provides such gliding action, the system may show a list corresponding to number of alternative databases. As an example, said number of databases may be represented by/on different keys of a second keypad of the invention, for example, having a three-by-three matrix of keys. The user may select one of the databases to be used by the system by providing a predefined interaction such as tapping on a zone corresponding to the desired database.
6. (a) A short/quick gliding action departing anywhere from said key rightward may correspond to fixing (e.g. keeping as is) a selected/highlighted character of a current predicted word. The system then selects/highlight another (e.g. the subsequent) character of the predicted word. (b) A long/press-and-holding-the-key-and-providing gliding action departing anywhere from said key rightward may correspond to fixing (e.g. keeping as is) all of the characters of a current predicted word. According to one method, additional (ambiguous) input information corresponding the current word may be added to the fixed characters so that the system better predicts aa current word being entered.
   Also as an example, on the Space key:
7. A pressing action anywhere on the key 102006 may correspond to the space (“Sp”) function.
8. A gliding (e.g. and holding) action upward departing anywhere from said key may correspond to the Shift function (↑) function.
9. A gliding action departing anywhere from said key downward may correspond to the “Enter” function.
10. A gliding action departing anywhere from said key towards upper-left side may correspond to dot “.” Character.
11. A gliding action departing anywhere from said key towards lower-left side may correspond to entering a predicted word wherein its beginning characters correspond to the input information provided by the user.
12. (a) During entering a word by interacting with the ambiguous keys, a gliding action departing anywhere from said key leftward may correspond to the rejecting (e.g. described later in this application) the predicted word. (b) During the correction procedure or when a word is not being entered the same gliding action may correspond to Undoing the last interaction with a key.

It is understood that although in this example (e.g. because the keys 102005, 102006, are close to the edge of the device) only five symbols on each key are considered to each being assigned to a gliding action in a different direction on/departing from the corresponding key, obviously, more or other symbols/function relating to different gliding directions may be considered for each key.

### Invisible, but Showing Shapes

According to one embodiment of the invention, in the invisible mode the approximate/exact location of the invisible letter keys on the screen may be marked by the corresponding common letter shapes (characteristics) if the system is in Letter Mode, or by the corresponding icons/informing means representing the corresponding group of special characters, if the system is in Special Character Mode. FIG. 103, shows limits/borders of the predefined zones of the keys in the Predictive Letter Mode. In this example, the borders of the invisible keys/zones are shown with discontinued frames lines because the borders/limits of the zones of the keys are preferably not (meant to be) shown on the screen/corresponding-surface. By using this embodiment, the screen of the device is free of keys and the user only may see four shapes each relating to its corresponding invisible key on the screen. According to one method, the location of the invisible space and invisible backspace keys (e.g. on the screen) may be marked by two icons for example such as “→” and “←”, accordingly.

### Insertion

According to one embodiment of the invention, providing a predefined gliding action from/on ambiguous key of the keypad may correspond to inserting the corresponding character at the cursor position within (e.g. at the end of) of a (e.g. the current) word. As an example, after entering the word “bat”, providing the gliding action 101110 may insert the corresponding special character “!” at the end of the word “bat”.

Accordingly, during the entry of the input information (e.g. ambiguous key presses) corresponding to a desired word, the user may also insert at least one precise/identified character/letter corresponding to any specific character position of the desired word. By combining said input information and the precise characters the system may more accurately predict a word.

Preferably, the insertion procedure is provided during an instance other than during the correction procedure. Preferably, during the correction procedure, providing a predefined gliding action from/on ambiguous key of the keypad may correspond to correcting/replacing a specific (e.g. selected/highlighted) character of a current (e.g. predicted) word by the identified character corresponding to the gliding action, and wherein the system may predict another word.

### Derivatives

A character and/or a chain of characters may have derivatives. As an example, the letter “a” may have different accented characters that may be considered as its derivatives. Some characters/chain of character may have derivatives that may be composed of one or more characters. For example, character “.” may have derivatives such as “.com”, “.net”, “.00”, etc.

According to one embodiment of the invention, after entering an identified (i.e. precise) character for example by providing a gliding action corresponding to Insertion during the entry of a desired word or during the correction procedure, if said identified character has derivative, the system may present them to the user. As an example each of such derivatives may be presented on a key of a second keypad having a plurality of keys.

According to one method, after the entry of a character that has one or more derivative characters such as accented characters, the system may show its corresponding derivatives on a second keypad. If the user does not desire to enter a derivative, he may ignore the presented derivatives. On the other hand, if the user desires to enter one (or more) of the presented derivatives, he may select it/them. To select a character, according to one method, he may either tap on a corresponding key or he may provide a gliding action on the screen.

According one method, after the user provides a gliding action corresponding to the original letter/special character on/from an appropriate key, at the end of the gliding action (e.g. after a pause without removing the finger from the screen, or after removing the finger from the screen), the system may show a second keypad of the invention including the derivative characters of the original letter/special character, respectively, either under the user's finger or on another location on the screen. The user then may provide an appropriate interaction on said second keypad or anywhere on the screen relating to a key of said keypad as described before, to enter one of said derivative characters assigned to a key of the second keypad.

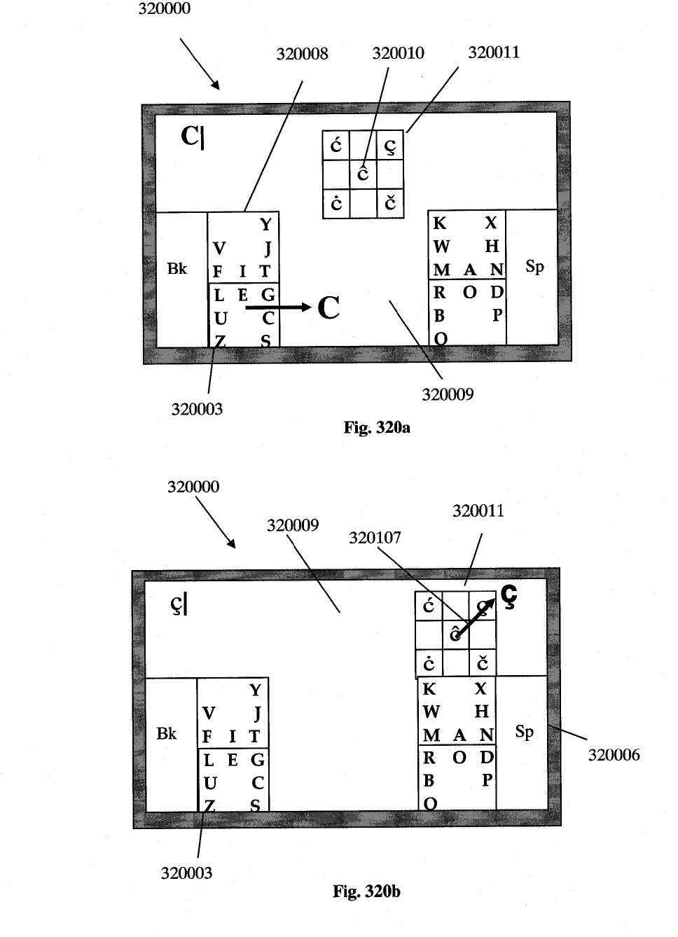

As an example, as shown in FIG. 320a, in order to enter the letter “₉” which is a derivative of the letter “c”, the user may first provide a corresponding gliding action on the key 320003 of the first keypad. The system may proposes/enter the letter “c”. In this example, after a pause the user removes his finger from the screen and the system showes on the screen a second a telephone-type keypad 320011 (e.g. having a 3×3 matrix of keys) having derivative (e.g. accented) characters of said shown/proposed character “c” on its keys may appear on the screen. At this time, as shown in FIG. 320b,—the user may provide the corresponding gliding action 320107 on or relating to a key to which his desired character is assigned on the new keypad and the system outputs/enters said derivative character (e.g. “ç”).

With continuous description of the current embodiment, based on the principle just described, other types of derivative characters such as for example “qu'” derived from the letter “q” as described in detail in other patent applications filed by this inventor, may also be entered similarly.

The method just described, may be applied for entering any other tree-form data such as looking for media search, entering precise characters, entering commands into devices, etc. For example, at a first touching point on the screen, a media search system may show a different type of media on each key of the second keypad. The user may select his desired type of media such as “music” through a corresponding gliding action. Then with his other finger, the user may touch anywhere on the surface, and the system may provide a different derivative such as “band”, “1970s” 1980s” “type of music”, etc on each key telephone keypad, and so on. According to another example, it can also be used for entering commands or functions within menu bars, etc. For example, word processor menu bars may be assigned to telephone-type keypad keys. The user may select one of the bars by providing a corresponding gliding action. When the system selects said bar, then (preferably before removing his finger from the touch sensitive pad), the user may touch on a location on the screen and the system may open another preferably similar keypad with contents of the bar. The user selects one of them and so on.

Based on the same principles, also precise characters may be entered. For example, the letters of a language may be grouped in several forms and each of them may be assigned to a key of a (e.g. telephone-type) keypad. Through the same method, first the user may select one of the groups, and then one of the letters of the selected group. If said letter has derivatives, then at the next stage, the user may select one of them.

Correct after Reject

According to a preferred embodiment of the invention, when a predicted word is presented to the user, he may either accept/confirm it, or he may reject it. When a user provides the input information (e.g. key presses) corresponding to a desired word and the system predicts a word and the user rejects the/said predicted word, the system may predict a new word (e.g. instead of the previous word.

Furthermore, according to a first method, the system may preferably automatically switch to the Precise Character Mode by switching the keys of the first keypad of the invention into their Precise (e.g. Letter) Mode instance (e.g. in the Precise Mode, according to one method, each of at least the letter keys of the first keypad may be considered as/replaced by a second keypad of the invention). At least two scenarios may be considered:

(a) if the new predicted word is the desired word of the user, then, the user may accept/confirm said new predicted word (e.g. by providing an end-of-the-word signal such as pressing on the Space key), or

(b) if the new predicted word is not the desired word of the user, the user may proceed to the Correction procedure by precisely entering at least one of the characters such as at least the first character of the desired word by interacting with the appropriate key (as described throughout applications filed by this inventor), for example, by tapping on the zone assigned to an appropriate identified character on a key of a first keypad in the Precise Mode (e.g. as mentioned before, in the Precise Mode, a key of the first keypad may be divided into a plurality of zone/keys each corresponding to an identified character. In the Precise Mode the plurality of divided zones/keys of the first keypad may be considered to form a corresponding second keypad. Therefore, tapping on a zone of the first keypad may be considered as tapping on the corresponding key of the corresponding second keypad.), or alternatively, by providing a gliding action on said key of the first keypad (i.e. when a gliding action begins on a key of the first keypad of the invention, the system preferably enters into the precise character mode (e.g. activated from an ambiguous key). Consequently, even if said gliding action is apparently provided on a key of the first keypad (e.g. the system may not change the appearance of the (interface) of the key), in reality it is provided on its corresponding second keypad in the precise mode) in the direction towards the/an appropriate identified character. By considering the input information provided until then (e.g. the key presses/interactions corresponding to the predicted word and the precisely entered at least first character) the system may predict a new word from the corresponding word database.

According to one method, each time the user enters an additional precise character and/or, according to one method, interacts with the system, the system may predict a new word. The user may repeat the Correction procedure until the system presents the user's desired word. If the user's desired word is not in the dictionary/database, the user may repeat the Correction procedure for all of the letters of the desired word. Alternatively, eventually the user may precisely enter (e.g. by the Correction procedure and/or the Insertion procedure) all of the letters of the desired word.

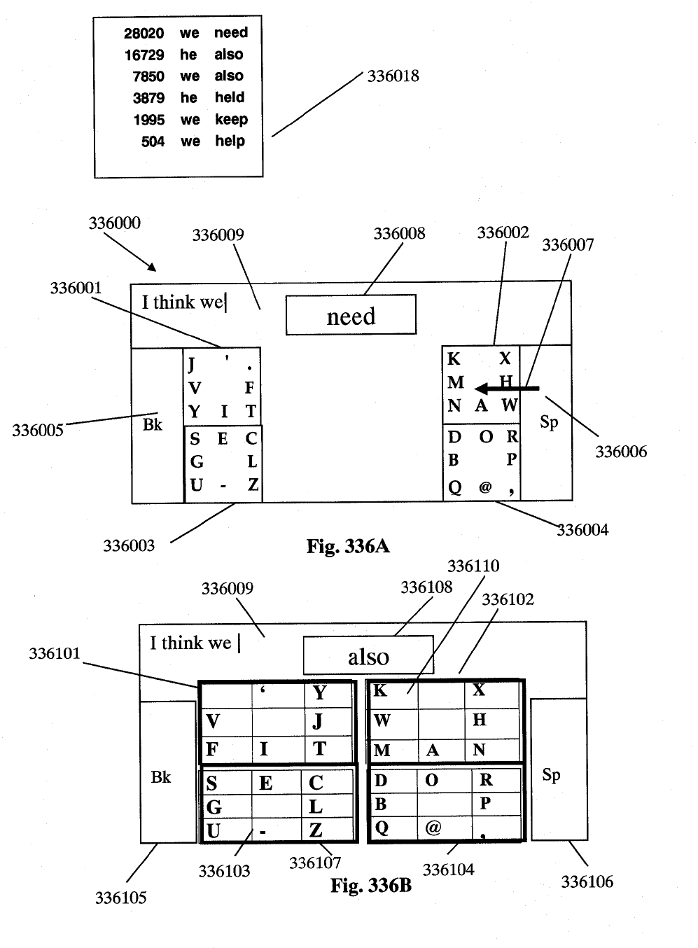

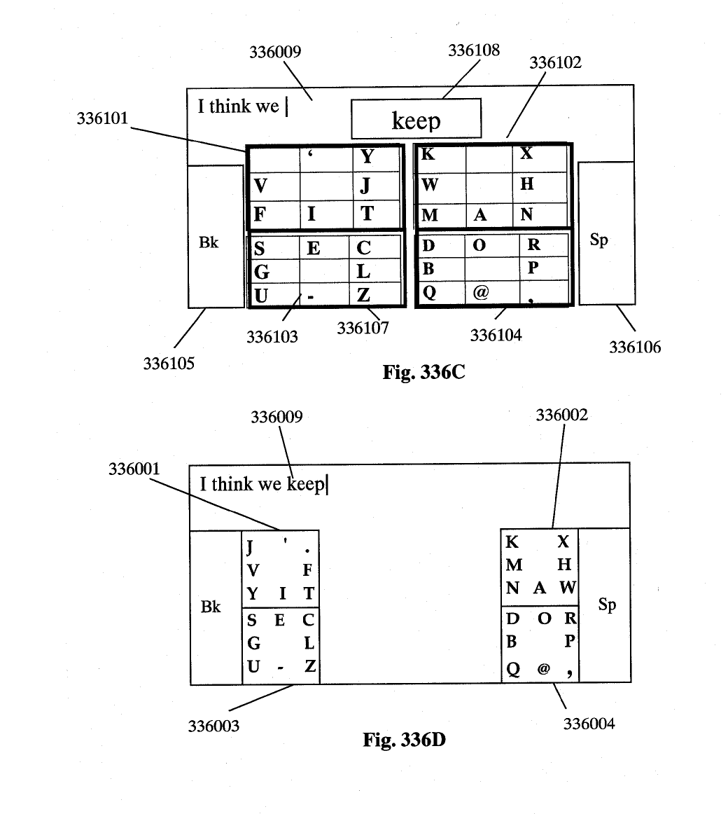

As an example, by considering the keypad of FIG. 336A, and using a 1-gram word database, if the user desires to enter the word “we”, he may press the keys 336002, and 336003. The system may propose/predict the word “he”. The user then may provide a gliding action such as the gliding action 336007 to reject said proposal. The system then, may propose a new word “as”, and enters into the Precise Character/Letter Mode and changes the appearance of the keypad by entering it into the Precise Mode. An example of such second keypads is shown in FIG. 336B, through the second keypads 336101-336104. If the new predicted word is still not the desired word, then the user may tap on the specific key/zone of the second keypad corresponding to the letter “w” (e.g. the first letter of the desired word). By considering the combined input information provided until now, the system may propose the word “we”, which is the desired word. The user may confirm the predicted/proposed word. Note that, in case the latest proposed word still is not the desired word, the user may precisely enter at least some of the remaining characters of the desired word by tapping on the specific keys/zones of the second keypad(s) (e.g. until the system provides the desired word).

Gliding Action Before and after Resection

According to one method, a predefined interaction, such as a predefined gliding action before or after rejecting the first predicted word, may correspond to different functions. As an example, according to one embodiment of the invention, during the entry of a desired word, a gliding action provided on or from a key in the direction of a letter/character on said key wherein said gliding action is provided before a Rejection action corresponding to rejecting the predicted word, said gliding action may correspond to an Insertion procedure/action of the invention (e.g. may correspond to inserting or adding an identified letter/character at the current cursor position of the Current predicted word) as described throughout this application and the previous applications filed by this inventor. Said/a gliding action, provided after said/a Rejection action, on or from said key in the direction of a letter/character on said key, may correspond to a Correction procedure/action of the invention (e.g. may correspond to replacing a selected/highlighted letter/character in the current predicted word by the/said letter/character corresponding to the direction in which the gliding action is provided) as described throughout this application and the previous applications filed by this inventor.

As an alternative method for providing an identified character, for example being used in the above mentioned embodiments and methods, for each highlighted/selected character of the Current word, the said second corresponding keypad of the invention may be located or displayed outside the letter keys. For example, if the system is using the first keypad on a first device such as a remote control for a media system (e.g. television, etc.), the second keypad may be displayed on a screen of a second device such as on the screen of a television.

### Linguistic Rules

The word predictive system of the invention may use an N-gram, preferably, at least a 2-gram word database. As such, when the user provides the input information corresponding to a desired word, in addition to considering said input information, the system may also consider at least one word and/or chain of characters preceding the current word being entered in the document. By considering/combining at least one preceding word (e.g. a chain of one or more precise characters, and eventually also considering the delimitating characters such as the space key(s) after said word(s), and the input information (e.g. ambiguous key pressed and eventually one or more identified character, if any) corresponding to the current word being entered, the system may predict a desired word with high accuracy.

According to a first method, said preceding at least one word and/or chain of characters may be at least one word (e.g. “the”) adjacent to the current word being entered (e.g. “mall”, that together may form a 2-gram word “the mall”) Accordingly, the N-gram database of words may preferably include corresponding N-gram entries.

According to a second method, said preceding at least one word and/or chain of characters may be not adjacent adjacent to the current word. As an example, according to one method, a number of predefined words such as “the”, “a”, “of”, “to”, etc., that may not provide enough information, may not be considered by the word predictive system when they precede the current word being entered. Accordingly, the N-gram database of words may preferably not include corresponding N-gram entries. As an example, in the phrase “go to the mall”, the considered 2-gram may be “go mall”. As such, after entering the consecutive words “go to the”, when a user is entering the input information corresponding to the word “mall”, the previously entered word “go” may be considered by the system as the previous (e.g. the adjacent) word.

According to one embodiment, a word list including said number of words may be created and used by the system. Accordingly, when using such system of search and the corresponding (e.g. large) database, when a the input information corresponding to a current word is being entered, the system may first look in said word list to predict one or more of word(s) of the word list corresponding to said input information. If there is/are such words, the system may first propose it/them to the user. If any of such a word(s) is the desired word, the user may confirm it. In this case, the system enters said word and does not search for corresponding words in the database. On the other hand, if there is no word in the list corresponding to the input information provided by the user or if the user rejects the word(s) predicted from the list, the system then proceed to searching for the corresponding words in said/the (e.g. large) database.

Based on the principles described above, the term “previous word(s)” relating to a current word being entered as described throughout this application may preferably be referred to the previous word(s) adjacent to the current word being entered. Depending on the method of the search and the corresponding database, according to ome method, said adjacent word(s) may be the adjacent word(s) excluding the words of said wordlist described above.

According to one embodiment of the invention, the word predictive system may be designed to use at least one N-gram (e.g. 2-gram) word database, based on the principles just described.

Correct after Reject—Using at Least an N-Gram (e.g. 2-Gram) Database

The data entry system of the invention based on accept/reject principles as described above may use an N-gram (e.g. 2-gram) word database. FIG. 336A shows an example, a portion 336018_of a 2-gram database of word used by the system. By considering the keypad of FIG. 336A, after entering the words “I think we”, the user may provide the (ambiguous) input information corresponding to a current word being entered by tapping on the keys 336002, 336003, 336003, 336004. By considering the (ambiguous) information and the previous (adjacent) word “we” (e.g. the precise chain of characters “we”), and eventually the space character provided after the word “we”, the system constitutes a combined input information and looks in the 2-gram database for the corresponding entries. In this example, such combined information corresponds to some of the entries of the portion 368018. The entry corresponding to the combined input information with highest priority includes the bi-gram “we need”. The system may propose the word “need” 3360008 corresponding to the (ambiguous) input information. If said word is the desired word, the user may confirm it, if not, the user may reject the proposed word by providing a predefined interaction such as providing voice command, or alternatively by providing a gliding action 336007 leftward from/on the space key. The system may relate the combined information to the next corresponding entry (e.g. “we also) of the database, and as shown in FIG. 336B, it may propose a new word: the word “also” 336108. Preferably simultaneously, the system may enter into the Precise Character Mode and may show several (e.g. four) second keypads 336101-336104 of the invention corresponding to the four ambiguous (letter) keys of the first keypad. If said new word is the desired word, the user may confirm it, if not, the user may tap on an specific key/zone of the second keypad corresponding to the first letter of the desired word. As an example, if the user taps on the key/zone 336110 corresponding to the identified letter “k”, then, as shown in FIG. 336C the system may propose the word “keep” 336108 corresponding to the 2-gram of the entry “we keep” (e.g. Alternatively, if the user taps on the letter “h”, then by considering the combined input information provided until then, the system may propose the word “help”). If said word is the desired word, the user may confirm the predicted/proposed word. Then, as shown in FIG. 336D, the system enters said word, and preferably automatically switches into the Predictive Mode.

It must be noted that a preceding word might either have been entered by the user or it may be part of a document used/opened by a user, and wherein after the user positions a cursor on/at the end of a word (e.g. after the space character after said word) within a document and begins to enter a current word, the system considers said previous word and/or another/other previous word(s) a as preceding word(s) before the cursor position.

### Edit a Word

According to one embodiment, when a user positions the cursor at the end of a word, the system may select said word and preferably highlights it for editing/correction. After the user edits said word, a confirmation action such as pressing the space key enters said word.

### Enlarged N-Gram (e.g. 2-Gram) Database

As mentioned above, according to one method, one or more N-gram databases such as preferably at least a 1-gram and a 2-gram database may be used by the system to predict words. As mentioned before, when the user provides the input information corresponding to a desired word (e.g. the Current word), there may be at least two scenarios:

a) if there is a preceding/previous word(s) which is correctly entered/predicted (e.g. within the corresponding text), the system may preferably consider both the preceding/previous word(s) preferably correctly entered/predicted combined with the input information corresponding to the Current word, and may process (e.g. compare/refer, etc.) the combined input information with the corresponding N-gram (e.g. 2-gram) word(s) of the database used by the system, and may predict (e.g. base on the combined input information) a Current Predicted Word for/corresponding to said input information provided by the user.

b) if there is not a preceding/previous word (e.g. the provided input information may relate to the first word in a text/paragraph, or the provided input information is provided after an end-of-the-word signal such as a period/dot character, etc.), then according to one method, the system may preferably refer to or use another database such as an N-gram database (e.g. a 1-gram database, and/or a 2-gram, etc.) wherein their first word (e.g. the first gram of their entries) is considered as being the first word of, for example, a text field, and/or of a paragraph, and/or a sentence, and/or a specialized data entry method or entity, etc. Accordingly, the frequency of use and/or statistics of use of such N-gram words may be different to those used, for example, in the middle of a sentence.

According to one embodiment of the invention, an N-gram (e.g. 2-gram) word database may include an (e.g. one or more) N-gram (e.g. 2-gram) word(s) that may include a special characteristic such as having a (e.g. including one or more) special character. For example, a 2-gram word (e.g. of a 2-gram word database) may include a special character such as, a “.” (e.g. dot), a “,” (e.g. a comma), or a character or set of characters (e.g. “\”, “\m” or CRLF) representing the “Enter” function/key of a keyboard, etc., as the 2-gram's first and/or as the 2-gram's second word (e.g. gram). By considering the principles herein described, after a user provides the input information corresponding to a desired word, the system may consider such database to use to predict a word. This may greatly enhance prediction performance and accuracy when the system predicts a single word, depending on the word's location within a text.

With continuous description of the current embodiment, as an example, hereafter an exemplary portion of an exemplary 1-gram word database (portion 1.1) and an exemplary portion of an exemplary 2-gram word database (portion 2.1) are shown.

Portion 2.1
Key presses 1 224

| | |
|---|---|
| , and | 734731 |
| i had | 457245 |
| i and | 452011 |
| . and | 410234 |
| . had | 398021 |
| . who | 52056 |
| , who | 37111 |
| , had | 11789 |
| i who | 5205 |

Portion 1.1
Key presses 224

| | |
|---|---|
| and | 5201500 |
| had | 890123 |
| who | 87101 |

In the 1-gram database portion 1.1, the order of the words based on their frequency of use is as follows: “and”, “had”, “who”. In the 2-gram database, if the first word of the 2-gram words (e.g. portion 2.1, note that the first words “.”, and “,” are represented by the key press value “1”) is the word “i”, then the order of the 2-gram words is as follows: “i had”, “i and”, and “i who”. In this case, as an example, after entering the word “i” correctly, and providing the input information relating to the key press value “224”, the system may first propose the word “had”. If the user rejects said word, the system may propose the word “and”. Accordingly, as an example, after entering the character “.” (e.g. at the end of a sentence), and providing the input information relating to the key press value “224”, then, by considering the previous word (e.g. in this example, the character “.” as the first gram of a word of the 2-gram database used by the system) the system may first propose the word “and” (e.g. in this example the character dot may be considered as the first character/word/gram of three of the 2-gram words “. and”, “. had”, and “. who” of the exemplary portion 2.1). If the user rejects said proposed word, the system may propose the word “had”. For entering the word “who”, according to one method, the user may proceed to the correction procedure.

Accordingly, as an example, after entering the character/word “,” (e.g. at the end of a word within a sentence), and providing the input information relating to the key press value “224”, the system may first propose the word “and” (e.g. in this example the character comma may be considered as the first character/word of three of the 2-gram words of the exemplary portion 2.1). If the user rejects said word, the system may propose the word “who”.

In the current embodiment, the N-gram (e.g. 2-gram) word database may include N-gram (e.g. 2-gram) words having a special character as one of their words/grams (e.g. preferably, as their first word/gram) representing the beginning of the text to be written in a text field, or beginning of a paragraph, etc.). For example, if the special character “\” represents the beginning of a paragraph and its key value is “1”, then, the 2-gram words “\ and”, “\ had”, and “\ who”, may be added to the portion 1.1 with a corresponding frequency of use of each of said words when they are written at the beginning of a paragraph. When a user enters one of said words, the system may know, for example, that the cursor is at the beginning of a paragraph (e.g. after a user interacts with the “Enter” key or provides a “Tab” function, the system may be informed that the cursor is at the beginning of a paragraph), and therefore, if the user provides the key presses corresponding to the key value “224”, the system may refer to the 2-gram words of the 2-gram word database having the character “\” as their first word/gram, and wherein their second word/gram corresponds to the key press value “224”.

By providing a word (e.g. a 2-gram) database based on the principles just described, the system may use only a single N-gram (e.g. 2-gram) word database to predict the desired word instead of using a group of word database(s) consisting of one or more word databases, such as, for example, a group consisting of a 1-gram and a 2-gram database. Several efficiencies and enhancements may now be incorporated into the system such that; for example, amongst others, memory usage, speed of search in the database, and simplicity of design may be enhanced.

According to one embodiment of the invention, an (N+X)-gram (e.g. 2-gram) word database may represent an (N+Y)-gram (e.g. 1-gram) word database where (N+X)>=(N+Y) and where X>Y. According to one method, preferably, an (e.g. one or more, i.e. X number of) identified character(s)/word(s) may be inserted before and/or after a (e.g. one or more) database entry/entries of an N-gram (e.g. 1-gram) word database to form a (N+X)-gram (e.g. 2-gram, for X=1) word database. For example, an identified character/word (e.g. ‘˜’) or a predefined code such as for example an unused ASCII code, etc., may be inserted before each database entry in a 1-gram word database (e.g. such as Portion 1.1) to form a 2-gram word database. Preferably, the inserted character (e.g. in this case the first gram) may be delimited from the second gram by a delimiter such as a space character. In this example, the system may search the 2-gram word database to find a 2-gram entry where, preferably, the 2-gram database entry also represents a (e.g. one or more) 1-gram entry from the 1-gram database. Also, for example, the system may represent a 2-gram entry of a 2-gram word database as a 1-gram word alone (e.g. without a relationship to an adjacent word in a sequence of words such as a sentence or a paragraph).

Depending on characteristic(s) of a word, such as for example, the position of said word within a text, or which special character precedes said word, etc., said word may be considered as an N-gram (e.g. 2-gram) word. Accordingly, said word and its characteristic(s) may form an N-gram (e.g. 2-gram) word of a corresponding word database wherein, preferably, each of said characteristic(s) may be represented by one or more symbols as one or more grams in said N-gram. For example, given the insertion/entry by the user of an identified character/word/gram such as ‘.’, ‘,’, “?”, ‘I’, “we” (e.g. as just described, in a bi-gram entry a (one or more) (special) character may be considered as a gram/word of said bi-gram word) followed by ambiguous input information corresponding to a desired word. Accordingly, the system may search for corresponding words (e.g. 2-gram words) in the database that include said identified character/word/gram and wherein their last gram/word corresponding to the input information provided by the user (e.g. it must be noted that some identified characters may represent the beginning of a sentence or a paragraph such as in the case of, “. want” or “, want” or “? want”, “i want”, and “we want”) to predict said word.

According to one embodiment of the invention, preferably, for an (e.g. one or more) N-gram word database and input information (e.g. user input from the user's interaction with the system through tapping on zones/keys, sliding from zones/keys, rejecting, accepting or confirming words and/or system input information such as identified inserted characters/words or special characters of an entry in an N-gram word database) where the information may contain a (e.g. one or more) precise and an (e.g. one or more) ambiguous character(s), the system may predict the user's desired word(s).

According to this embodiment, for a scenario, where, for example, the input information may consist of a first set of characters (e.g. consisting of one or more characters) of an N-gram (e.g. 1-gram or 2-gram) that are precisely identified (e.g. ‘a’, ‘1’, ‘that’, ‘that?) and a remaining set(s) of character(s) including/consisting-of at least one ambiguous character (e.g. wherein an ambiguous user interaction may be considered to represent any character in a set/group of character(s)), the system may search an N-gram word database to predict the user's desired word(s).

Creating an N-Gram (e.g. 2-Gram) Database (e.g. From a Corpus of Words) to be Used by the System

Based on the principles described above, an exemplary N-gram database may be created (e.g. as a derivative of a corpus) to be used by the system is described below:

1. The database may include corpus-based N-Gram frequency list, wherein, preferably, N=2 (i.e. “bigrams”). The database may also include other N-Gram frequency lists, wherein N>0. For the purposes of this invention, a 1-Gram is either a word (token) a number (e.g. integer, fraction, etc.), a combination of characters and/or punctuation marks and/or special characters, or other symbol(s) or a sequence of symbols identified/counted as they may occur in a corpus (i.e. without being divided into morphemes and/or in any other manner) which preferably are not space-delimited. Punctuation marks may also be identified as 1-grams.
1a. For the purposes of this invention, according to one method, “word” is any sequence that includes at least one character in an alphabet, preferably, used by a language the frequency list refers to, and, preferably, is not space-delimited. I.e. if a plurality of special characters/digits occur at any position in the word, and there is no space between the letters and the digits/special characters, such sequences are considered “words” and included into the count just as they occur in the corpus. According to a second method, “word” is any sequence of characters regardless of its characteristic (e.g. including letters, or excluding letters).
2. According to this principle, the contracted forms and possessive constructions (“I'm”, “can't” “wanna”, “cat's”, “cats'”, etc.) are preferably considered as single words/grams and may be referred to as undivided. Thus the frequency list contains entries like “cat's tail”, “wanna do”, “I'm here” etc.
3. By using the same principle, hyphenated words may preferably remain undivided. E.g. “socio-economic status” may preferably be considered as a 2-gram.
4. The count is preferably case sensitive. E.g. both “the south” and “the South” may occur in the list as separate entries. According to one method, it may not matter where in the word the upper case letter(s) occur(s), and how many upper case letters there are (e.g. words like “ASAP”, “iPad” etc. may preferably be listed as they occur in the corpus).
5. According to one method, the bigrams may include punctuation mark characters, wherever they occur in the bigram-initial position.
E.g. sequence “Why? Because” may preferably produce bigram “? Because”.
5a. According to one method, in addition, the punctuation mark characters may be considered as an integral part of the bigram-initial word and, as such, the bigram may be included into the bigram count.
E.g. “Hello! My”, “really? We”, etc.
5b. According to one method, in addition, the punctuation mark characters may be considered as an integral part of the bigram-final word and, as such, the bigram may be included into the bigram count.
E.g. “Hello My!”, “really We?”, etc.
5c. A sequence of two or more punctuation marks may be counted as it occurs in the corpus. E.g. “But why?! I think . . . May be . . . ” may result in the following bigrams:
“But why”
“why?! I”

### “?! I”

“I think”
“think . . . May be”
“ . . . May be”

### “ . . . May be . . . ”

6. The punctuation marks that have an opening and an ending or may be considered as pairs of symbols (e.g. ( ) [ ] “ ” { } < >) may preferably not be included into the count of the frequency list. Instead, they may function as boundaries that the count will not cross.
E.g. the sequence “some fruits (usually, apples) can cause” may result in the following bigrams:
“some fruits”
“usually, apples”
“, apples”
“can cause”
The following sequences, however, may preferably NOT constitute bigrams, and thus may not be included into the count of the frequency list:

| | |
|---|---|
| ”fruits (“ | |
| ”( usually” | [brackets preferably should not be included into the count] |
| ”usually ,“ | [comma appears in bigram final position] |
| ”apples )” | |
| ”apples can” | |

“fruits usually”

7. The count may include numbers and special characters wherever they precede a word (i.e. are followed by a space, and then, by a word).
E.g. “5 o'clock”, “24 years”, “203 trees”, “$20 US”, “20$ in” etc. may be considered bi-grams.
7a. For this purpose, a “number” is a digit or any sequence of digits which are preferably not space-delimited, as well as any sequence of characters that is preferably not space-delimited and may consist of at least one digit and a special character(s)/punctuation mark(s), irrespective of where their position in this sequence.

### E.g. “3”, “20/8”, “−1.5”,“1,000,000”, “−1”, “35.7%”, etc.

7b. According to one method, any numbers and/or special characters that occur after a word (i.e. after a space that follows a word) are preferably not included into the count of the frequency list E.g. “after 54 years” may result in the bigram “54 years”.
Yet “after 54” may preferably NOT be counted as a bigram.
7c. According to another method, any numbers and/or special characters that occur after a word (i.e. after a space that follows a word) are preferably included into the count
E.g. “after 54 years” may preferably result in the bigrams “54 years” and “after 54”.
7d. According to one method, if there are consecutive chains of characters comprising digits/special characters separated by Space, they preferably are not counted as bigrams, unless a number/special character precedes a word.
E.g. the sequence “at 534 67 89 any time” will result in the following bigrams only:
“89 any”
“any time”
I.e. for the purposes of this invention, preferably sequences like “at 534”, “534 67”, “67 89” may not be considered as bigrams and may not be counted in the frequency list.
7e. According to another method, if there are consecutive chains of characters comprising digits/special characters separated by Space, they preferably are counted as bigrams.
E.g. the sequence “at 534 67 89 any time” may preferably result in the following bigrams:
“89 any”
“any time”
“at 534”
“534 67”
“67 89”

In the cases of 7-7e, in an N-gram (e.g. 2-gram) word created as such, the number(s) may preferably be replaced by at least one predefined code/symbol or a special character (e.g. “#”), depending on their types (e.g. “23”, “23.5”, “−23”, “23/5”, “23%”, etc.). As an example, the bigrams “89 any”, “123 apples”, and “5.8 kilometers”, may be replaced, respectively, by the bigrams “# any”, “# apples”, and “*kilometers”. Accordingly, as an example, if the system uses a bigram word database, when a user enters the input information corresponding a current (e.g. predicted) word being entered, wherein said word is preceded with a number, the system may search in the database for entries wherein their first gram is the relevant predefined code/symbol (e.g. special character) representing said type of number and wherein its second gram may correspond to the input information provided by the user.

8. “Return” (“Enter”) may be treated as if it were a “Space”. E.g. in the following text:
Have you seen her?
Yes, I have.
“? Yes” may preferably constitute a bigram.
9. The beginning of a document in the corpus may be marked by a predefined code/special character/symbol such as, for example, “A”. For example, this may result in bigrams such as “A Hi”, “A Dear”, etc. Accordingly, during the entry of the input information corresponding to a word, the system may check/identify if the word being entered is the first word of a document, and thereby search in the database for the entries wherein their first gram is the character (e.g. “̂”) representing the beginning of a document, and the other corresponding gram (e.g., the second gram of bigrams) corresponds to the input information relating to the current word being entered
10. The database may be organized so that each entry includes an N-gram (e.g. 2-gram) word and is related to its frequency information. Thus the format of the database or frequency list may be, for example, as follows:

Frequency[TAB]Var1[TAB]Var2 E.g.:

| | | |
|---|---|---|
| 235 | same | reason |
| 220 | ! | However |
| 200 | 7 | books |
| 198 | us, | they |

11. According to one method, a gram other than the first gram of a an N-gram entry (e.g. the second gram of a 2-gram entry) may include or be constituted-of any type of character(s) such as letters and/or special characters (e.g. digit, punctuation mark, etc.) and/or a mixture of them.
12. According to one embodiment, a type of chain of characters excluding a letter may occur as the first and/or another gram of an N-gram entry of the database. e.g.:
“2@# xwmy”
“code 34$%&”
“f34&*T54G”

The current database may also include 1-gram words in form of N-gram (e.g. 2-gram) words. There may be many 1-gram words with high frequency in the corpus that constitute 2-gram words having low frequency of use. Such N-gram words may not be desired to be included in the N-gram database. In this case, such 1-gram words with high frequency may be modified to form N-gram (e.g. 2-gram) words wherein their first gram is a (one or more) special character (e.g. “'”) or a code (e.g. ASCII code), and as such they may be included into the N-gram database. Preferably, to said special character a key value may also be assigned. According to one embodiment, after the user provides the input information corresponding to a desired word, the system may also consider the previous word relating to said input information and may search in the N-gram (e.g. 2-gram) database. If there is no corresponding N-gram word, the system may replace the previous word by the special character/code representing 1-gram words/chain of characters (e.g. including at least one character) of the N-gram database and search for N-grams wherein their first gram is said special character/code and their other gram (e.g. the second gram) corresponds to the input information provided by the user. If said database is a 2-gram word database, and the system finds a corresponding entry, it may propose the second gram of the entry as the predicted word.

As mentioned, the database created above, may preferably, be case sensitive. As such, during the entry of a word, if the user provides a predefined interaction such as providing a “shift” information/function relating to one or more characters of the word being entered, the system may consider said information and may look/search for the corresponding words within the database. According to one embodiment, if such a word with the specific case(s) is not found, the system may inform the user. According to another method, if such a word with the specific case(s) is not found, the system may look/search for a word corresponding to the input information provided by the user in the relevant database regardless of the said case(s).

In the embodiment just described, if the desired word is not in the dictionary, the user may proceed to the correction procedure. After entering such a word, the system may add it as an N-gram (e.g. 2-gram) word to the database wherein its first gram is said special character/code.

It must be noted, that the example of arrangement of an N-gram (e.g 2-gram) database described above is used to demonstrate the main principles of creating such a database. Changes to such an arrangement may be considered by people skilled in the art. For example, such an arrangement may exclude any of the exemplary cases described above, or it may include additional cases which are not described above.

### Order of Search in a Databases

According to one embodiment of the invention, the system may use more than one databases with different number of grams/word. As an example, the user may use a 2-gram database and a 1-gram database.

According one method, based on the input information received by the processor used by the system combined with a (one or more) preceding words, the system may first search in the N-gram database for entries corresponding to the combined information and wherein their entire last gram corresponds to the input information relating to the current word provided by the user. If the system does not find a corresponding entry, different scenarios may be considered:
1. According to a first method, the system searches within the 1-gram database for entries wherein their entire last gram corresponds to the input information relating to the current word provided by the user. if it does not find a corresponding entry, then:
   a. The system searches within the N-gram database for entries corresponding to the combined information and wherein the beginning portion of their last gram corresponds to the input information relating to the current word. If it does not find a corresponding entry, then:
   b. the system searches within the 1-gram database for corresponding entries wherein their entire last gram corresponds to the input information relating to the current word. if it does not find a corresponding entry, then:
2. According to a second method, the system searches within the N-gram database for entries corresponding to the combined information and wherein the beginning portion of their last gram corresponds to the input information relating to the current word.
   a. the system searches within the 1-gram database for entries wherein their entire last gram corresponds to the input information relating to the current word provided by the user. if it does not find a corresponding entry, then:
   b. the system searches within the 1-gram database for corresponding entries wherein their entire last gram corresponds to the input information relating to the current word.

### Words Including Special Characters

According to one embodiment of the invention, in addition to the letters of a language (e.g. divided based on their common shapes and) assigned to a number of keys such as for example four keys, special characters may be divided into several groups (e.g. four groups, such as those shown and described throughout this application and other patent applications filed by this inventor) based on their common characteristics and each group being assigned to a separate key (e.g. to said four keys). They may be inputted as part of a current word being entered.

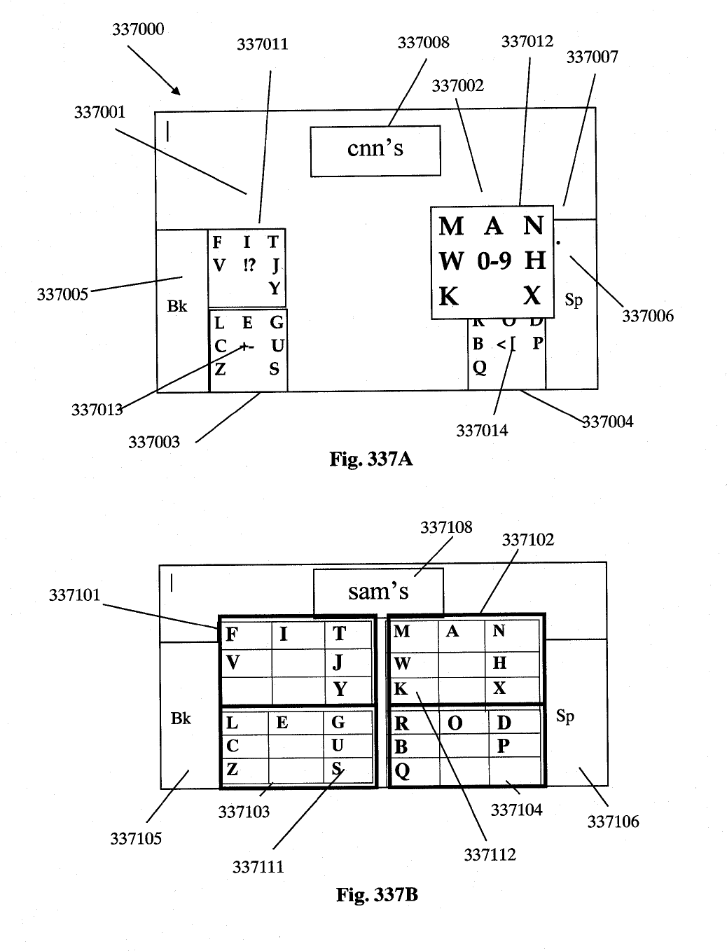

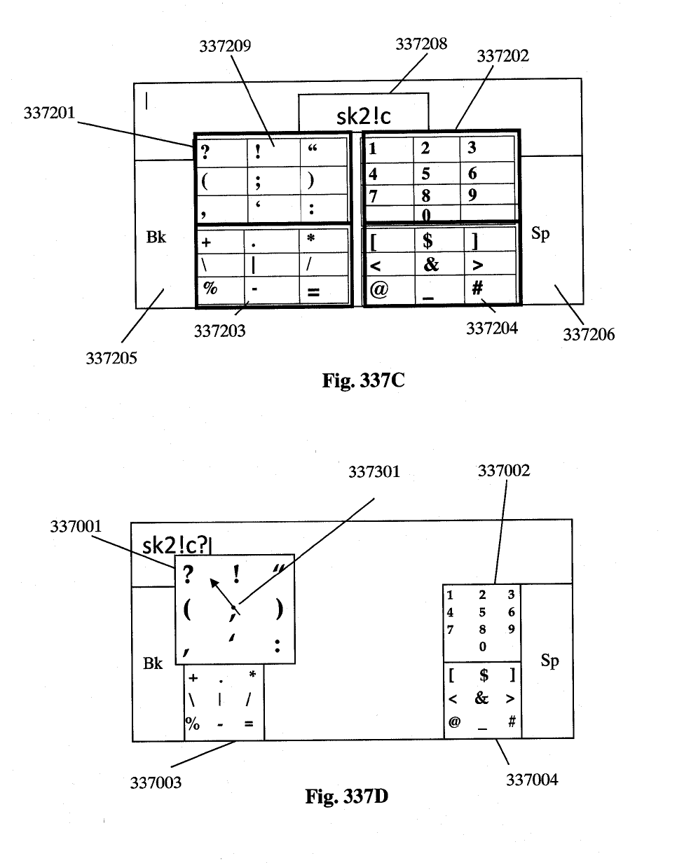

As an example; FIG. 337A shows the distribution of special characters on four keys of the first keypad of the invention. In this example, the punctuation mark characters are assigned to the key 337001 and are indicated by an icon 337011, the digits 0-9 are assigned to the key 337002 and are indicated by an icon 337012, the arithmetic characters are assigned to the key 337003 and are indicated by an icon 337013, and other (e.g. rarely used) characters are assigned to the key 337004 and are indicated by an icon 337014. It must be noted that some exceptions may be considered in this distribution. For example, the characters “#” and “@” are assigned to the key 337004. It must be noted that the common characteristics as just described is one of many other characteristics that may be considered by people skilled in the art.

According to one embodiment of the invention, a tapping action on a key may ambiguously correspond to any of letters and/or special characters assigned to said key. Accordingly, the words (e.g. entries) of a dictionary/database of words may include any of said special characters and/or other characters. As an example, in order to enter the word “Sk2! C”, the user may tap the on the keys 337003, 337002, 337002, 337001, and 337003. The system may at first predict the word “cnn's” 337008 which may have the highest priority (e.g., itself or its corresponding N-gram) among the corresponding database entries. The user may reject the predicted word, and as shown in FIG. 337B, the system may propose another corresponding word for example the word “sam's” 337108 for example the word corresponding to said key presses and having for example the next highest priority. This word is still not the desired word, therefore the user may proceed to the correction procedure. As shown in FIG. 337B, the user may first tap on the key 337111 relating to the letter “s”, the system may propose the word “shave” (not shown). If this is still not the desired word, the user then, may tap on the key 337112 corresponding to the letter “k”. The system may propose the word “skate” (not shown) which still is not the desired word. Now, as shown in FIG. 337C, the user may (e.g. manually) enter the system into the Precise Special Character Mode, and tap on the key 337209. The system may propose the word “sk2!c” 337208.

Alternatively or in addition to the principles described above, according to one embodiment of the invention, providing a first type of interaction for example such as a short pressing action (e.g. a tapping action, pressing a key for less than a predefined laps of time) on a key of the first keypad may ambiguously correspond to a letter assigned to said key, and providing a second type of interaction such as a long pressing action (e.g., pressing a key for at least a predefined laps of time) or a (very) quick/short gliding action (e.g. in any/a predifined direction) on a/said key may ambiguously correspond to a special character assigned to said key (or vise versa). This may help the system to better predict a word that includes letters and special characters, because the user may inform the system which type of character (e.g. a letter or a special character) must be in a specific position within a word being entered by providing corresponding short and long pressing actions. It must be noted that according to one method, the short gliding action may ambiguously correspond to both letters and special characters, and the long pressing action may correspond to the special characters only (or vise versus).

According to one method, different key values may be assigned to the long pressing actions on the keys of the first keypad, and to the characters of the corresponding groups.

According to one embodiment, in addition to or instead of the special characters, a predefined interaction such as a long pressing action or a short gliding action on a/any (e.g. such as for example a letter) key may (e.g. also) ambiguously correspond to a letter assigned to said key, but may also inform the system to search within a specific group of entries in a database for a word being entered. According to one method, said specific group of entries may include words with specific characteristics such as words belonging to SMS vocabulary, medical vocabulary, etc. By doing so, the system may better and quicker predict a desired word. According to one example, if the user taps on the keys 337003, 337004, and long presses on the key 337003, the system may look for two types of words, a first type consisting of words corresponding to the key interactions wherein their last character is a special character, and a second type consisting of words belonging to the SMS vocabulary. In this case the word “LOL” may have the highest priority, and the system may propose said word. Otherwise, if the user provides (short) tapping actions on 337003, 337004, 337003, the system would have provided another word such as the word “los” having highest priority in the corresponding general entries of the/a database. Note that in the current embodiment, according to one method, said specific group of entries may constitute or be considered a separate database and/or be also included or be considered as being part of the non-specific (e.g. general) entries/words within/of a/the database.

According to one embodiment of the invention, a special character may (e.g. ambiguously) be assigned to more than one key of the keypad of the invention.

According to one embodiment, according to a first method, providing a first type of interaction with a key of the first keypad of the invention such as pressing said key for a predefined short period of time, and, preferably subsequently, providing a desired gliding action towards a letter on said key may correspond to entering said letter precisely (e.g. for insertion/correction). Accordingly, providing a second type of interaction with a key of the first keypad of the invention such as pressing said key for a predefined longer period of time and, preferably subsequently, providing a desired gliding action towards a special character on said key may correspond to entering said special character precisely (e.g. for insertion/correction). In the current embodiment, when the user provides the first type of interaction (e,g, with a key) the letters are shown on the appropriate key, and when he provides the second predefined interaction (e.g. with a key), preferably, instead of the letters the special characters may be printed/shown on said key. FIG. 337A shows, as an example, the letter of the alphabet being assigned to the keys 337001 to 337004 of the first keypad of the invention, and FIG. 337D shows, as an example, the special characters assigned to the same keys 337001 to 337004. When a (letter) key (e.g. 337001) is pressed and held for at least a predefined amount of time, the system may enter said key into its special character mode, and may enlarge said key. Accordingly, as an example, a special character may be entered precisely by press-and-holding an appropriate key and providing an appropriate gliding action. During the entry of a word, this procedure may be used and may be repeated if necessary until the system predicts the desired word. In this embodiment, according to another method, the first type of interaction may be assigned to entering special characters and the second type of interaction may be assigned to entering letters.

During the entry of a word, inserting precisely a special character (e.g. “!”, ?, “.”, etc.) as part of a word being entered may be confusing for the system, because the system may not know if the user either intends to insert said character as being part (e.g. a character) of a word being entered or as a character separately from/regardless of the word being entered. For example, after the user enters the word “MP3”, (e.g. by tapping action on the keys 337002, 337004, 337002, or, by tapping on the keys 337002, 337004, and long pressing action on the key 337002), the system may propose the word MP3, inserting the special character “?” precisely may provide the word/chain of characters “MP3?”. The system may not know if the intended word is the word “MP3” or the word “MP3?”. To resolve this problem, different embodiments may be considered. Some of such embodiments are described hereafter:

According to a first embodiment, if at least one of said words/chain of characters is not in the dictionary/database of words used by the system (e.g., as an N-gram), the system may, automatically or by asking the user, add said at least one word to the database of words. This may augment the number of words of the dictionary/database significantly, and may reduce the accuracy of the prediction. This method may be time consuming and distracting for the user.

According to a second embodiment, if a special character is entered before providing an end-of-the-word signal, said special character may be considered as being part of the word being entered, and if said special character is entered after an end-of-the-word signal said special character may not be considered as being part of the word being entered.

According to a third (e.g. a preferred) embodiment, a gliding action provided (e.g. before/after rejecting a predicted word) on any of the letter keys of the keypad of the invention, may correspond to inserting a corresponding character (e.g. letter, special character) precisely, and a tapping on a key of any of the second keypads of the invention in the precise mode (e.g. in Precise Letter Mode or Precise Special Character Mode) may correspond to correcting/replacing a corresponding ambiguous/precise character of the predicted/proposed word by the appropriate precise character being entered. If there is no ambiguous or precise character to correct (e.g. none of the characters of the word being entered is selected/highlighted, or all of the characters of the current word are being fixed/modified as precise characters), the system may insert the precise character at the cursor position in (e.g. to the end of) the current predicted word. Preferably, the precise character provided through the Precise Letter Mode or through the Precise Special Character Mode, may be considered as part of the current word being entered. According to one method, the special character provided through a gliding action may preferably not be considered as part of the word being entered. As an example, after a word is being entered for example by tapping on the keys of the first keypad or after a correction procedure, inserting a precise special character through a gliding action may insert said character at the end of said word, regardless of said word (e.g. said character is preferably not a part of said word), and may be considered as an end-of-the-word signal. For example, after the system predicts the word “cost” without requiring a correction, or after the system predicts the word “golf” through the correction procedure (e.g. by a tapping action on the letter “G” of the appropriate second keypad of the invention), inserting the character “?” through a gliding action on the corresponding letter key of the (e.g. first) keypad in its special character mode, may insert said character “?” at the end of any of said words. In the current method, preferably, a precise letter inserted through a gliding action may be considered as part of the word being entered.

According to another embodiment of the invention, a chain of characters (e.g. preferably excluding a space character) wherein at least one of its special characters is entered precisely through a gliding action may be considered by the system as a word. Different scenarios regarding such a word may be considered:
1) After entering such a chain of characters, if the user provides an end-of-a-word signal (e.g. space character), the system may consider said chain of characters as a word, and if said word is not in the appropriate word database (e.g. dictionary), the system may enter said word to the appropriate (e.g. 1-gram, and/or N-gram wherein N>1) word database.
2) After entering such a chain of characters, wherein at least one of its letters is ambiguous, if the user provides a rejection interaction, the system may enter into the correction procedure of the invention as described earlier (e.g. the system may also simultaneously propose another corresponding word (e.g. if any exists) of the word database of the system.
   In the scenarios described above, according to one method, if the user desires to enter a special character such as a “?” or “!”, or etc. at the end of the chain of characters/word but not being as part of it, the user may first enter/confirm said word and then may provide said special character.
   Automatic Switch into the Precise Character Mode

According to one embodiment, at any moment during the entry of a word, if the input information provided by the user does not correspond to a word of the word database used by the system, then, the system may automatically enter into the Precise Character Mode Instance. The user then, may use the letter keys in said mode to enter precise character(s) (e.g. by tapping on the corresponding letter/letter-zone on a letter key). As a first example, during the entry of a word, if the user provides ambiguous key presses, several scenarios may be considered such as:

1—If at some point, the system does not find a word corresponding to said key presses, then the system may automatically enter into the Precise Character Mode Instance, and the user may use the letter keys in said mode to enter precise characters replacing the predicted characters. After replacing said predicted characters, if the user continues to enter precise characters, they will be Inserted at the cursor position (e.g. they will be added at the end of replaces characters)

2—After providing all of the ambiguous key presses corresponding to his desired word, if the system predicts a non-desired word, and the user may perform a Correction procedure to for example correct at least some of the characters of the predicted word, and at some point the system does not find a word corresponding to the combined input information provided by the user, then the system may automatically enter into the Precise Character Mode Instance, and the user may use the letter keys in said mode to enter precise characters replacing the predicted (e.g. ambiguous) characters of the predicted word. After replacing said predicted characters, if the user continues to enter precise characters, they will be Inserted at the cursor position (e.g. they will be added at the end of replaced characters).

### Modifying the Previous Word(s)

According to one embodiment of the invention, during the entry of a current word, the system may consider the input information (e.g. ambiguous key press value(s) corresponding to the characters of a previously entered word/s (preferably one or more previously entered word/s adjacent to the current predicted word being entered), and eventually may also consider more related information (e.g. if one or more characters of a previously entered word/s is being entered precisely) here after referred to a previous input information, and combine said previous input information with the input information corresponding to the current word being entered, to predict two and/or more words, respectively. If the new predicted word(s) corresponding to the previous input information is/are different from the previously entered word(s), and the user confirms said predicted word(s), then according to one method, the system may replace the previously predicted word(s) by the corresponding new predicted words. According to a preferred method, a single confirmation action may also enters the predicted word corresponding to the current word being entered.

As an example, by considering the keypad of FIG. 101, key pressing actions 101002, and 101001 may correspond to each of the words “at”, and “my”. The word “at” has higher priority/frequency; therefore the system may propose the word “at”. Knowing that the predicted word (e.g. ‘at’) may be replaced later, the user may proceed to entering the next word by tapping on the space key and providing the input information (e.g. tapping the appropriate keys) corresponding to the word “name”. The same input information may also correspond to the word “make” which has higher priority/frequency than the word “name”. By considering the input information corresponding to the previous word “at”, and the space character precisely entered after this word, and by considering/combining with the input information corresponding to the current word being entered and comparing the combined information with the corresponding entries of a 2-gram database, the system may propose two new words (e.g. a 2-gram word) “my name”, which hase the highest priority/frequency among the corresponding 2-gram entries in an word (e.g. 2-gram) database. According to one method, if the user confirms said 2-gram word, the system replaces the previously entered word “at” by the word/gram “my”, followed by a space character, and adds/enters the current predicted word “name”.

### Word Completion

According to a preferred embodiment, the system may search within the N-gram (e.g. 2-gram) database for several types of words, such as below:
at least one word of a first type of words, wherein all of its characters correspond to the input information provided by the user; and
at least one word of a second type of words wherein its beginning characters correspond to the input information provided by the user;
   According to one method, the system may preferably propose/present one word from the first type of words and/or one word from a second type of words to the user.
   Languages with Hieroglyphic system of writing (e.g. Chinese/Japanese)

### Phonetic Characters

As mentioned before, the data entry system and its features such as using an N-gram database to predict a word may also be applied, for example, to languages with a hieroglyphic system of writing wherein their input system may be based on the phonetic alphabet/transcription such as Chinese and Japanese. In fact, each of said languages are based on a set of characters, respectively, Roman characters and phonetic characters. In a Roman-based language a set of Roman characters constitute a word, in languages with a hieroglyphic system of writing (e.g. Chinese, Japanese) a set of phonetic characters constitutes a phonetic transcription system (e.g. Pinyin, Bopomofo, Romaji), or a phonetic alphabet (e.g. Japanese alphabet Kana). A Chinese or a Japanese word/word segment (e.g. represented by a hieroglyph(s)/ideogram symbol) written in Pinyin, Bopomofo, Romaji or Japanese alphabet Kana is hereafter referred to as “Phonetic Word” and/or “phonetic word”, etc. Accordingly, the principles of the data entry system using an N-gram (e.g. 2-gram) database may be applied to in the same manner to predict a word of a Roman-based language or a Phonetic Word. Note that, a Phonetic N-gram database may be a collection of N-gram Phonetic Words.

According to one embodiment of the invention, the N-gram principles of predicting a word as described throughout this application may be applied to the phonetic N-gram (e.g. 2-gram) databases such as Pinyin, Bopomofo, Romaji and Kana (e.g. including Hiragana, Katakana) wherein, preferably, each gram of an N-gram entry of the database may be related to one or more ideogram symbols constituting a word (e.g. Chinese or Japanese characters). Accordingly, after a phonetic set of characters (e.g. a word's phonetic transcription such as Pinyin, Bopomofo, Romaji, or a word written in Japanese alphabet Kana, hereafter referred to as “phonetic word”) corresponding to an ideogram symbol is correctly predicted by the system, the system/user may select the corresponding ideogram symbol.

For purposes of clarification of the above, as mentioned before, in addition to a language using Roman characters, the data entry system and its features, such as using an N-gram database to predict a word may also be applied, for example, to a language with a hieroglyphic system of writing (e.g. such as Chinese and Japanese) wherein their input system may be based on a phonetic alphabet/transcription. Therefore, the principles of the data entry system of the invention described throughout this application and the previous applications, filed by this inventor, may be applied to entering text in any language using an alphabetical input system such a as phonetic alphabetical system (e.g. such as Chinese and Japanese) and/or other types of alphabetical characters such as Japanese Kana.

In a Roman-based language a set of Roman characters constitute a written/printed word, while in a language using a hieroglyphic system of writing, a phonetic transcription may represent a written/printed hieroglyphic word, wherein said hieroglyphic word may include one or more hieroglyphs. A phonetic transcription representing a hieroglyphic word is hereafter referred to as “Phonetic Word”. Accordingly, the principles of the data entry system using an N-gram (e.g. 2-gram) database may be applied to in the same manner to predict a word of a Roman-based language and/or a Phonetic Word. Note that, a Phonetic N-gram database may be a collection of N-gram Phonetic Words. Note that in many cases several hieroglyphic words may be represented by a same Phonetic Word.

According to one embodiment of the invention, the N-gram principles of predicting a word as described throughout this application may be applied to the phonetic N-gram (e.g. 2-gram) databases, for example, such as Pinyin, Bopomofo, Romaji and Kana (e.g. including Hiragana, Katakana) wherein, preferably, each gram of an N-gram entry of the database may be related to one or more ideogram symbols constituting a word (e.g. Chinese or Japanese characters). Accordingly a first method, after a Phonetic Word, (e.g. including phonetic transcription(s) such as Pinyin, Bopomofo, Romaji, etc.) corresponding to a hieroglyphic word, is correctly predicted by the system, the system/user may select a corresponding hieroglyphic word. According to a second method, after the user inputs the information corresponding to some of the beginning characters of a Phonetic Word that its beginning characters correspond to said information, and/or alternatively the system may predict a hieroglyphic word corresponding to said information.

As an example, hereafter shows two portions of an exemplary phonetic (e.g. Pinyin) 2-gram phonetic word database and the exemplary corresponding Chinese words and key presses.

Keypress: 43231 43

| 2-gram | 2-gram |
|---|---|
| (phonetic) | (hieroglyphic) |
| benci qu | [symbol] |
| renzi de | [symbol] |
| oumei ru | [symbol] |
| qunei bu | [symbol] |

Keypress: 1123 222

| 2-gram | 2-gram |
|---|---|
| (phonetic) | (hieroglyphic) |
| ting ama | [symbol] |
| jixu kan | [symbol] |
| timu nan | [symbol] |
| ting wan | [symbol] |

When the system is used for entering text in languages with hieroglyphic system of writing (e.g. Chinese, Japanese), preferably, in addition to the Phonetic N-gram database(s), the system may include an N-gram (e.g. 1-gram and/or 2-gram) database of hieroglyphic words. According to one embodiment of the invention, during the entry of the input information and/or after the system predicts correctly a first Phonetic Word (e.g. based on the input information such as at least one of, key presses, reject action, correction procedure, etc., as described before in this patent application), preferably, the system may propose a corresponding hieroglyphic word (e.g. as the best choice) for example the corresponding hieroglyphic word having the highest frequency of use, preferably within the corresponding words of an appropriate database of hieroglyphic words (e.g. preferably a 2-gram database, or a one-gram database, etc.) corresponding to the instance/location of the desired hieroglyphic word within the text that the user is entering. Preferably after confirming the predicted Phonetic Word, at least two scenarios may be considered:
a) If the predicted hieroglyphic word is the desired word, the user may proceed to entering a next desired Phonetic Word or another interaction (other than a rejection procedure that will be described in scenario (b) hereafter), and the system may enter said hieroglyphic word.
b) If the predicted hieroglyphic word is not the desired word, then according to one method, the user may Reject the predicted hieroglyphic word by providing a predefined interaction, preferably the same interaction used for rejecting a Phonetic word. The system may propose another hieroglyphic word. Preferably, the system may also propose a selection of additional corresponding hieroglyphic words (e.g. if any). At this time at least two possibilities may be considered
   a. If said another predicted hieroglyphic word is what the user desires, then as described above, the system user may proceed to entering a next desired Phonetic word or another interaction, and the system may enter said word.
   b. If said another predicted hieroglyphic word is not what the user desires, then, the user may select his desired hieroglyphic word among the proposed additional hieroglyphic words.

The selection of additional corresponding hieroglyphic words may preferably be arranged in one or more (e.g. such as up to four) second keypads (e.g. preferably, having a three by three matrix of zones/keys) of the invention, as described and shown throughout the applications filed by this inventor. To select one of said additional hieroglyphic words, according to a first method, the user may tap on said word, wherein according to a second method, the user may touch the corresponding second keypad of the invention and provide a gliding action towards the desired hieroglyphic word. Providing a tapping or a gliding action to select a symbol on a three by three matrix of keys/zones has already been described in detail in the patent applications filed by this inventor.

With continuous description of the current embodiment, according to one method, the hieroglyphic words of the selection may be assigned to the one or more second keypads of the invention based on for example their common characteristics such as their shape, meaning, sound, number of hieroglyphic symbols of a word, etc.

According to another embodiment of the invention, during the entry of the input information and/or after the system predicts correctly a first Phonetic Word (e.g. based on the input information such as at least one of, key presses, reject action, correction procedure, etc.), preferably, the system may propose a corresponding hieroglyphic word (e.g. as the best choice) for example the corresponding hieroglyphic word having the highest frequency of use, preferably within the corresponding words of an appropriate database of hieroglyphic words (e.g. preferably a 2-gram database, or a one-gram database, etc.) corresponding to the instance/location of the desired hieroglyphic word within the text that the user is entering. Preferably after confirming the predicted Phonetic Word, at least two scenarios may be considered:
a) If the predicted phonetic and hieroglyphic words are correct, the user may press Space to confirm/enter the word.
b) If the predicted phonetic word is not a desired word, then according to one method, the user may Reject the predicted phonetic word by providing a predefined interaction. The system may propose another phonetic word. At this time, at least the following possibilities may be considered:
   a. If said another predicted phonetic word is what the user desires, as well as the hieroglyphic word, then as just described above, the user may confirm both the Phonetic and the hieroglyphic words, and the system may preferably enter the hieroglyphic word.
   b. If said another phonetic word is not the desired word, then the use may proceed to the correction procedure until the system predicts the correct word, and may proceed to the possibility (c) as described below.
   c. If said another phonetic word is the desired word but the another predicted hieroglyphic word is not what the user desires, then, the user may Reject the predicted hieroglyphic word by providing a predefined interaction, i.e. by providing a predefined interaction such as for example gliding from the Space key upwards. The system may predict another hieroglyphic word and may propose a selection of additional hieroglyphic words. The user may either confirm said predicted word or select his desired hieroglyphic word among the proposed additional hieroglyphic words.

The selection of additional corresponding hieroglyphic words may preferably be arranged in one or more (e.g. such as up to four) second keypads (e.g. preferably, having a three by three matrix of zones/keys) of the invention, as described and shown throughout the applications filed by this inventor. To select one of said additional hieroglyphic words, according to a first method, the user may tap on said word, wherein according to a second method, the user may touch the corresponding second keypad of the invention and provide a gliding action towards the desired hieroglyphic word. Providing a tapping or a gliding action to select a symbol on a three by three matrix of keys/zones has already been described in detail in the patent applications filed by this inventor.

With continuous description of the current embodiment, according to one method, the hieroglyphic words of the selection may be assigned to the one or more second keypads of the invention based on for example their common characteristics such as their shape, meaning, sound, number of hieroglyphic symbols of a word, etc.

### Bopomofo

According to one embodiment of the invention, Bopomofo (Zhuyin Fuyao) phonetic symbols are classified into four groups and assigned to the four (e.g. letter) keys of the first keypad of the invention and preferably may be used to enter Phonetic words preferably based on principles as described for other phonetic alphabets above. The said classification may be based for example on the traditional way of their writing. As an example, the symbols may be arranged into four groups as following:

The first group may preferably include the symbols that may be written with a single stroke: [symbol] (e.g. this group may include two exceptions: [symbol] [symbol] )
The second group may preferably include the symbols in which the first or the last stroke is a horizontal stroke [symbol] [symbol]
The third group may preferably include the symbols in which the first or the last stroke, is a vertical stroke [symbol] (e.g. this group may include two exceptions: [symbol]
The fourth group may preferably include the symbols which preferably may not be included within one of the first three groups, and wherein in their writing/shape they include a diagonal right-to-left stroke or a diagonal left-to-right stroke (e.g. of any kind such as long or short).

[symbol]

[symbol]

### Korean

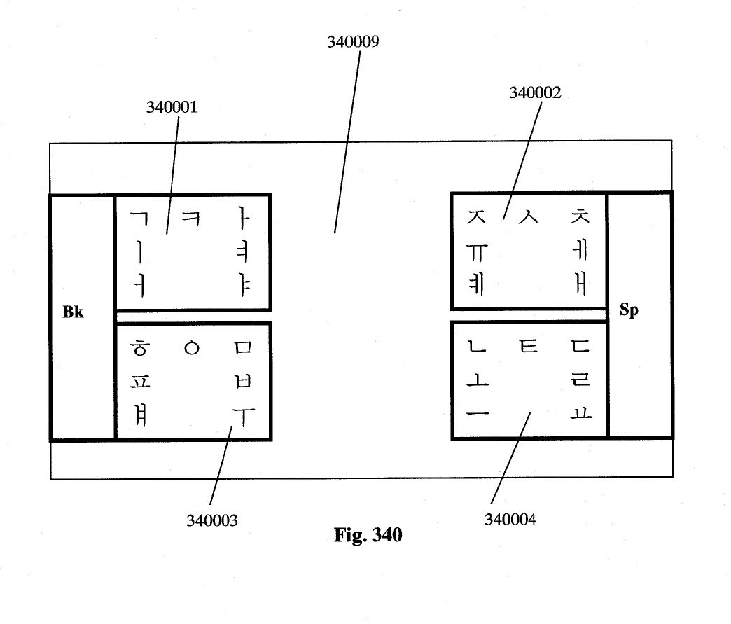

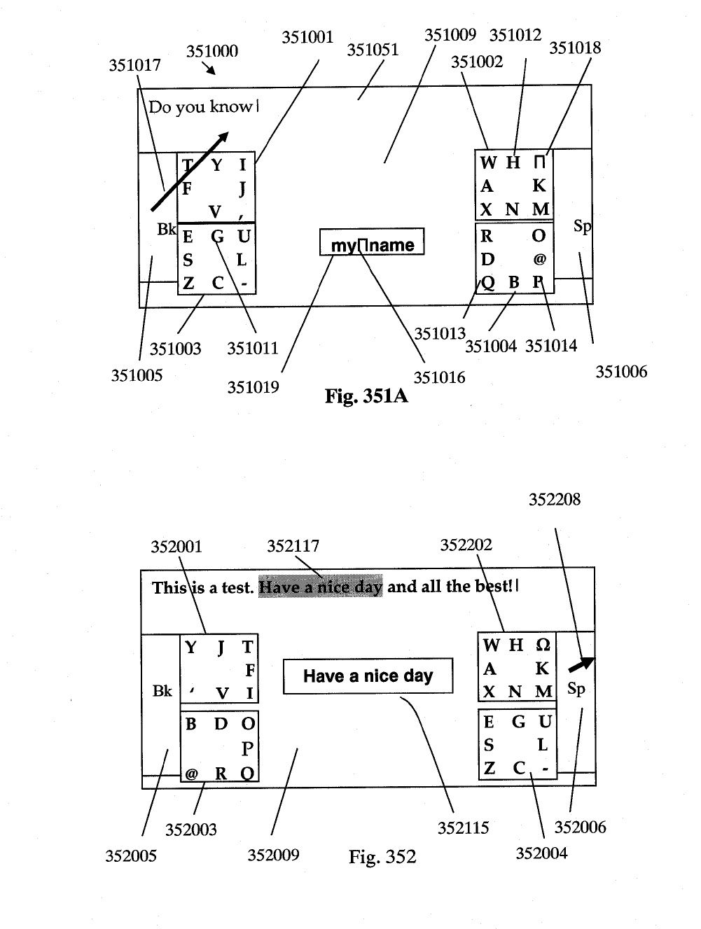

The assignment of the letters/characters to the keys of the first keypad based on their common characteristics such as a portion of their shapes may be applied to the characters of any language. FIG. 340 shows as an example the assignment of the Korean letters to four keys of the first keys pad accordingly. As an example, key 340001 mostly includes the letters that stand on one point (as referred to as “leg”), key 340002 mostly includes the letters that stand on two points/legs, key 340004 mostly includes the letters that stand on a horizontal line, and key 340003 mostly includes the letters that have a closed zone within them. For reasons such as for example to augment the accuracy of the prediction, there may be some exceptions in assigning the letters to the keys. For example, the letter “T” which stands on one point/leg generally belonging to the key 340001, is exceptionally assigned to the key 340003 in this example.

It is understood that the examples of distribution of letters on the keys of a (first) keypad based on the common shapes as provided above are only exemplary. Other kinds of distribution and/or other common portions of letters/characters may be considered and accordingly assigned to any predefined number of keys by people skilled in the art.

### Calibration

According to one embodiment of the invention, interacting (e.g. preferably simultaneously) with two predefined vertical zones each covering substantially all of a surface of a different side (e.g. two opposite sides) of the screen of a device in portrait or in landscape mode may be related to relocating/recalibrating the keys of the first keypad of the invention under the interaction location. In addition in order to access to the content under those two zones, a switching means such as predefined interaction for example, with a key of the first keypad may be provided to remove those zones and next time to bring them back on the screen.

According to another method, providing a press-and-holding action (e.g. for at least a predefined period of time) with each of (e.g. at least) a pair of the user's fingers (e.g. with two thumbs), preferably simultaneously, anywhere on a surface such as a touch screen may locate/relocate each of the (two) portions of the (e.g. split) first keypad of the system (e.g. such as the portions of the split keypad of FIG. 101A) under a corresponding user's finger at the corresponding press-and-holding action impact/point on the screen (e.g. under the user's fingers), respectively. Preferably, the border between the two letter keys of each portion (e.g. or alternatively a specific key of each portion) may be under the appropriate touching point. According to one method, in order to eliminate the ambiguity between a mouse function and the calibration procedure, the system may include a software object in form of a virtual grid covering preferably substantially the entire said surface (e.g. of the touch screen). Said grid (which may be of a physical/virtual interface form) may be an invisible grid for example comprised of continued or discontinued very thin (e.g. crossing) lines or very small spots (e.g. one to few pixels in size, or made of one to few pixels, respectively) distanced far enough from each other such that to maximize the visibility of the output/content displayed on the screen but close enough such that when a user touches (e.g. anywhere on) the surface with a finger, the finger touches both the screen under the grid and the grid. By using such grid, during calibration, the data entry system may detect the user's finger(s) (e.g. thumbs) touching points/locations on the screen, along with the operating system of the device. According to one method, the data entry system may inform the operating system to ignore the mouse function and may relate said interaction to the calibration procedure, while according to another method, both the operating system and the data entry system operate in response to the user's interaction (e.g. the mouse interaction event and the calibration of the keypad). Detecting user's interaction location on the screen using such a grid may be used for other purposes too. According to one method, such grid may be designed in such a way that detection of the user's interaction may occur without the user touching said surface.

The calibration/recalibration procedure just described, may enable a user to interact with the system (e.g. through a touch screen surface) without looking for the input interface. At any moment, the user may define where the interface should be/is.

By using this method of calibration, in other word, the user's fingers (e.g. thumbs) become the input interface. When a user provides a calibration procedure, the impacts of his fingers above, and/or below the touching points, and on a/the left position/location and/or on a/the right position/location of/relating-to the touching points (e.g. in a predefined radius/zone around the calibration touching points), may relate to providing the input information corresponding to the group of characters assigned to said impacts.

### Compound Word

A compound word is a sequence of words being connected to each other by a connector. The connector may preferably be a predefined character/code. According to one method, the connector may be assigned as an ambiguous character to a letter key. According to another embodiment the connector may be assigned to another key such as the space key. In some cases the connector may be the space character itself. In such case, an entry of a database including several words delimited by each other with a space character may be considered as a 1-gram entry.

A compound word is generally considered by the system/user as a single word/unit. The connector generally represents a space character between the words of a compound word.

Generally when a user enters a space character at the end of entry of a word predicted by the system, said space character is considered by the system as an end-of-the-word signal which confirms the acceptance of the word predicted by the system. In such case, according to one method, either the connector character is to be a character other than a space character, or the system may be designed in a way that the space character is considered to be a part-of-a-compound-word character, and not an end-of-a-word signal.

If the connector is a special character, then, when the system predicts a compound word, it may replace the connector(s) by a space character(s) before it presents the compound word to the user.

As mentioned, a compound word is a single word formed by two or more single words connected to (e.g. or considered to be connected to) each other to form a single word. Obviously most of time a compound word consists a long word. Searching in a database including compound words may provide results with high accuracy. The entries of a database of words may include one or more compound words.

A compound word may preferably be entered using a database of words including compound words. If a compound word does not exist in the database the system/user may add it to the database.

FIG. 351A shows as an example, an electronic device 351000, having a screen 351009. The device also includes the data entry system of the invention including A first keypad of the invention having the keys 351001-351006, including the letter keys 351001-351004. One of the ambiguous characters of the key 351002 is the connecting character/connector 351012. As such, in order to enter the words “my name” as a single word, the user may tap on the appropriate keys corresponding to the letters of both words including a tapping action on the key 351002 corresponding to the connecting character between the two words. If such a compound word exists in the database, the system may propose it to the user, and the user may confirm it. On the other hand if such a compound word does not exist in the database, the user may proceed to the correction procedure of the invention to enter its characters, including the connector character, precisely. At the end of the entry the user/system may add the compound word to the database.

According to one embodiment of the invention, a plurality of (e.g. prefererably, consecutive) words of a document/text printed on a screen may be selected by (e.g. by the user) and be added as a single/compound word to the/a database.

As an example, as shown in FIG. 352, shows an as example, touch sensitive surface of a device 352009 on which a text is printed. The user may select a portion 352117 of said text having several words/chain of characters, by for example, using the native selecting functions of the device. At this time, according to one method, the user by using a using a predefined interaction/means such as providing a gliding action 352208 in a predefined direction, may inform the system to add said portion of text as a single word to/as an entry of the database.

Preferably, when the user selects a portion of the text it may be brought to the foreground 352115 (e.g. in the window corresponding to the current word) so that the user may edit said portion of text (e.g. as a single word), if desired. According to one method, after the portion is selected (e.g. and brought in the foreground), providing an end-of the word signal such as tapping on the space key may confirm the entry of the word.

As mentioned, according to one method, a compound word presented to the user and/or added to the database may include connecting character(s) such as the character(s).

The use of compound words with the data entry system of the invention reduces or eliminates the use of the correction procedure for predicting a word by the system.

The use of compound words may be specifically beneficial for searching in a database relating to contents such as for example the name of the streets (e.g. “seventh-street”), or a the name of a music band (e.g. “Rolling-Stones”), etc.

### Content Search Such as GPS—Tap to Accept

According to one embodiment of the invention, providing/performing a gliding action in four different directions provided anywhere on a touch sensitive surface may respectively correspond to interacting with four letter keys of the system. Preferably, the directions may be towards any of the following: upper left, upper right, lower left, and lower right. Furthermore, gliding actions in other directions such as left, right, up, and down, may correspond to other symbols such as special characters, and functions. For example, a gliding action leftward may correspond to backspace function, and a gliding action rightward may correspond to providing a space character. Also, according to one method, a tapping action on a sensitive surface may correspond to another symbol such as a confirmation function.

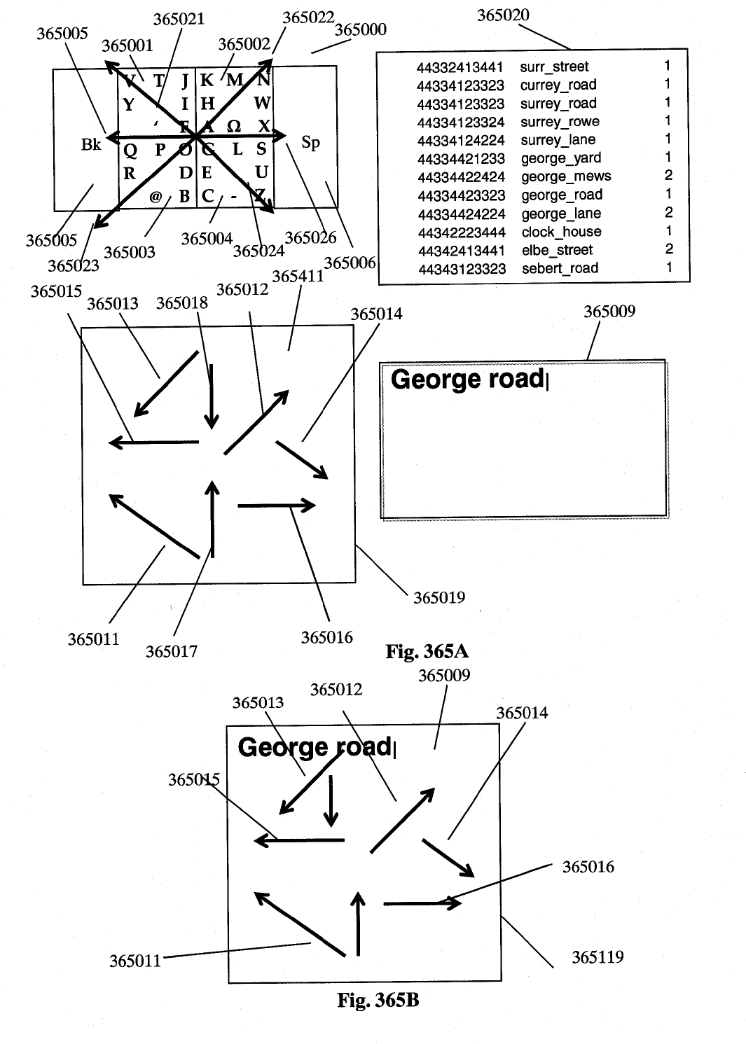

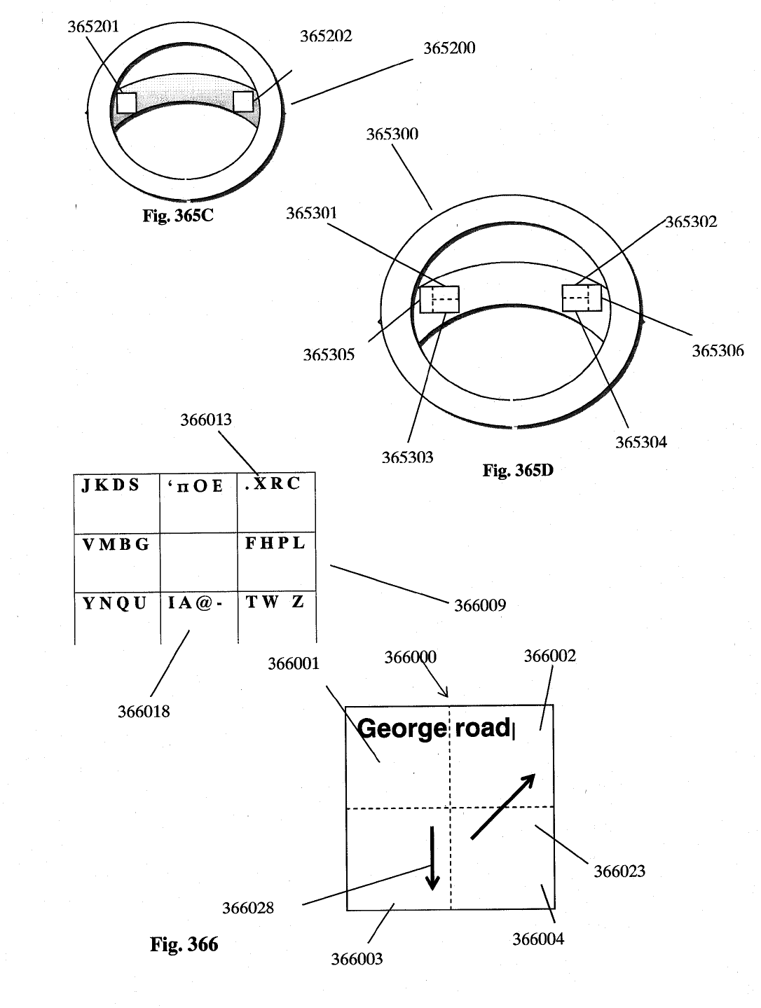

The directed gliding actions such as those just described above may be used to enter data in devices such as those mainly using a sensitive surface to input data. One of those devices is the Global Positioning System (“GPS”) device. According to one embodiment of the invention, as shown as an example in FIG. 365A, a GPS device having a touch sensitive surface 365019 to enter data, and a separate screen 355009 to output data, may include the data entry system of the invention. Gliding actions provided anywhere on the touch sensitive surface 365019 may imitate/duplicate gliding actions provided from the center of an imaginary keypad model 365000 towards a corresponding key of said keypad model 365000. For example, the gliding action 365013 provided on the touch sensitive surface 365009, imitates the gliding action 365023 corresponding to interacting with the key 365003 of the imaginary keypad 365000. As shown, by using the touch sensitive surface, according to one method, if the user provides the gliding actions, 365014, 365014, 365013, 365013, 365014, 365014, 365012 (for space/connector), 365013, 365013, 365012, 365013, the system may propose the corresponding street name comprising the combined word “George Road”.

According to one method, the system may include an N-Gram (e.g. word) completion system so that, during the entry of an N-Gram (e.g. single word, combined word) of the relevant N-Gram database, if there is only one corresponding word (e.g. a longer word), wherein this word corresponds to the user's interaction(s) with keys, and is other than the word or chain of characters being entered, then the system may also propose the longer word.

According to another method, during the entry of a word using a (e.g. an N-Gram) database, if there are two or more corresponding words (longer words), wherein these words correspond to the input information provided by for example user's interaction(s) with keys and differ from the word or chain of characters being entered, wherein these words may preferably be assigned different frequency values, the N-Gram (e.g. word) completion system may also propose the longer word of the highest frequency. Said method may preferably be applied to all the embodiments of the invention.

According to one embodiment of the invention, a tapping action may be assigned to confirming a proposed/predicted word. Also as an example, a gliding action provided from anywhere in a direction such as upward may relate to a previous page/field, and a gliding action provided from anywhere in a direction such as downward may relate to a next page/field, or vice versus.

According to one embodiment of the invention, the dynamic database used by the system may be based on the context of a text/document at a relevant instance.

According to one embodiment, the keyboard/keypad mode instance may automatically change in accordance with different type(s) of context. For example, if a field requires entry of letters, the keyboard/keypad may be in letter mode (e.g. the mode wherein interacting with the four letter keys generally correspond to letters), and if a field requires entry of digits and does not require entry of letters, then the keyboard/keypad may automatically enter into the special characters mode such as at least one of the letter keys enters into the digit mode, and preferably, also other letter keys represent different group of special symbols as described throughout this application. In the example of FIG. 365A, according to one method, if the user is asked to enter a house number, then the keypad 365019 may be defined such that gliding actions in different directions on it correspond to entering numbers based on a telephone keypad keys as described earlier in this application. In this case, a different interaction such as a long/double pressing action may be related to confirming the number entered.

In the current example, if the input information provided by the user may correspond to more than one words/candidates of the database, then, the system may propose them to the user by a means such as using a text to speech means/software to pronounce them, or showing them on a separate screen 365009 of the invention as described before. In this case, the user may provide an appropriate interaction such as pronouncing a candidate word he/she has selected, whilst a speech to text means/software is being used, or, for example, performing an appropriate gliding action to enter/select one of them. According to one method, when candidates are proposed to the user, a gliding action provided on the screen (e.g. preferably towards a candidate) may be related to selecting a candidate. According to one method, the system may show them on a three by three matrix based presentation as described earlier. Said selecting interaction/gliding action may be provided on any of the sensitive surfaces 365019 and/or 365009. According to one method, instead of a single gliding action, a back-and-forth gliding action in the direction of the desired candidate may be provided to select one of the candidates proposed to the user.

According to one embodiment of the invention, the system may be designed in a way that the user does not have to enter all the elements (e.g. words) of an N-Gram such as a name of a street (e.g. when he/she is looking for a map, is using the GPS, is searching for a movie, is using any other content search application, etc.). In such a case, the system may use information corresponding to a portion of one or more entries of the database to select/consider them.

A gliding action provided from anywhere upwards (e.g. 365017) and a gliding action provided from anywhere downwards (e.g. 365018), may, for example, be assigned to functions such as going to the next field, or going to other pages such as a homepage, a GPS directory, etc. As an instance, when the user begins to enter an address, the system may first require from a user to enter a country or a state name by, for example, locating a cursor/focus on a field (on a screen) corresponding to the names of countries. After entering and confirming it, by, for example, providing a tapping action on a surface, the user may provide a gliding action 365018 and, as a result, the system may focus on the next field corresponding to entering a city name. According to one method, the gliding action downwards may confirm the country name being entered and move/skip the focus to the city field. In this case the tapping action for confirmation may not be required. The gliding actions downwards and upwards may navigate the focus of the system between the fields back and forth.

According to one embodiment, multiple gliding actions in a predefined direction such as a gliding action downwards may navigate the focus of the system on different fields in a loop manner. In this case, the gliding action in another direction (e.g., 365017 may be used for other functions such as entering the system into its homepage, etc.

In a case when the system is focused on a field designed to receive digits, a predefined interaction such as a long pressing action may be used to confirm the digits entered and eventually exit (e.g. remove the focus) from that field.

According to one embodiment of the invention, in some cases such as if an application field requires the entry of ambiguous characters/letters (which may imply using the word predictive mode of the system) alongside with precise characters, then the interactions of the first type (such as quick gliding actions) may correspond to entering the ambiguous characters, and interactions of the second type (such as slow gliding actions) may correspond to entering the precise characters. A slow gliding action has been described before by this inventor. For example, a slow gliding action may be a slow motion during the entire instance of the gliding action or during a portion of it such as in the beginning or in the end of said gliding action. According to another method, the interaction of the second type may be another predefined interaction such as a back-and-forth (or, for example, forth-and-back) gliding action corresponding to a character such as a digit assigned to a predefined second keypad model (e.g. a telephone-type keypad) such as those described before. According to other methods, said interactions of the first and the second type may be, correspondingly, short and long gliding actions, soft and hard gliding actions provided on a surface sensitive to different levels of pressure applied to it, etc.

In the example shown in 365A, the GPS screen may be the screen of a first mobile device such as a smartphone, and the separate pad for entering data may be the screen of the second mobile device such as a smartphone. A wireless/wired communication means may be applied between the two devices. The (e.g. processing of) data entry system of the invention may be executed either in any one of the devices or in both of them. The same applies for any number of mobile devices used in accordance with this embodiment.

With continuous embodiment of the current example, the input means and the output means may be the same means such as a touch screen of a device (such as a GPS device or a mobile communication device 365119 as shown in FIG. 365B). According to one embodiment, both the input and the output means may be integrally associated with one device.

According to one embodiment, the system may include at least two input surfaces/pads. As an example, FIG. 365C shows a steering wheel 365200 of an automobile wherein two input surfaces 365201 and 365202 are provided on it. As an example, providing interactions such as gliding actions on the surface 365201 may correspond to entering numbers, and providing interactions such as gliding actions on the surface 365202 may correspond to other functions such as entering letters, space, backspace, and up/down arrow functions as described for FIGS. 365A-B. This assignment may be changed/reversed. The term steering wheel may apply to any navigational means of any transportation means.

The split surfaces used with the data entry system described above may be either integrated within the steering wheel or it may be a detachable/attachable unit attached-to/detached-from the steering wheel. The split surfaces may be wirelessly or by wired connected to the rest of the system.

### Two Pads Integrated or Add-On

According to one embodiment, as shown in FIG. 365D, the system may include two input surfaces/pads wherein tapping actions on predefined zones on them represent interacting with the keys 365301-365306 of the split keypad of the invention as described and shown earlier. On the other hand, gliding actions on one of the surfaces may correspond to a certain function such as a correction procedure of the invention and/or selecting a candidate, and gliding actions provided on the other surface may correspond to another function such as entering digits and/or selecting a candidate.

According to one method, a connector character may be entered precisely during the input of information corresponding to an (e.g. N-Gram) entry of a database. The connector character may preferably be assigned to another key such as the space key, or a key other than the keys of the first keypad. In this case, the ambiguous connecting character represented by the letter key (e.g. 365302) may be removed from said key. As mentioned before, a precise input of a connecting character may significantly augment the prediction accuracy, so that the system often may predict the desired content before the completion of entering the entire input information, hence saving (reducing the number of) interactions.

Note that the methods of content search described throughout this application are not applied only to the contents mentioned: they may be applied to any type of content. For example, the methods of data entry in the GPS can be applied for another type of content search such as searching songs, videos, movies, filling the fields of an e-shopping page, etc.

According to one embodiment of the invention, instead of (or in addition to) displaying the text/word being entered by the user, the system may use a text to speech software to pronounce the text/word being entered by the user. By combining this method with using the gliding actions for entering text a completely eye-free text entry solution may be provided.

The data entry system just described, may be used for any vertical application wherein preferably the corresponding word database has a limited number of word. One example of those applications may be such as an SMS application using mainly SMS customized word and/or abbreviations. Another example may be a data/text entry application for secret agents or army personals using customized or even coded words. It must be noted that the ambiguous keys of the keypad of the system may include any character such as letters and/or special characters.

### Text Entry Using Gestures

According to one embodiment of the invention, the data entry system with which the user interacts mainly by gestures as just described and shown, may be used for general data/text entry. For example, after the system proposes a word based on the user's gliding actions corresponding to the letter keys, a back-and-forth gliding action in a predefined direction may correspond to a precise letter assigned-to/located-on the key that pressing on said key provided the first ambiguous character of the predicted word. The system may propose another word corresponding to the combined input information, and so on. Accordingly, if a user desires to enter a special character, he/she may first provide a gliding action corresponding to a letter key to which his/her desired special character is assigned when the system is in special character mode. At the end of the gliding action, the user may pause for at least a predefined lap of time. Said pausing action may enter the system into the special character mode. Now, according to one method, the user may provide a second gliding action towards his/her desired special character. Said second gliding action may be provided without removing the finger at the end of the first gliding action or after removing the finger at the end of the first gliding action. In both cases, preferably, the corresponding key in the special character mode may be shown under the user's finger as described throughout this application. According to another method, the second gliding action provided after the first gliding action (and pausing) without removing the finger at the end of the first gliding action may correspond to a function such as selecting a precise character (e.g. letter), whereas the second gliding action provided after the first gliding action (and pausing) after removing the finger at the end of the first gliding action may correspond to another function such as selecting a special character.

According to another embodiment, a predefined interaction such as a gliding action provided from the outside/edge of the screen inwards (on the screen), preferably, in a predefined direction may correspond to entering the system into a mode instance such as the correction procedure. Same interaction in another direction may correspond to entering the system into another mode instance such as the special character mode, etc.

### A Gliding Action Upward, or Downward

According to one embodiment of the invention, tapping actions on different letter zones such as four letter zones on a sensitive surface may correspond to entering (e.g. ambiguous) letters/N-Grams, whereas gliding actions on that surface may correspond to other functions such as correction procedure of the invention based on gliding actions as described throughout this application.

As an example, after the user provides tapping actions corresponding to a word being predicted by the system, the user may provide an appropriate gliding action relating to a key of the second keypad (e.g. based on a keypad model) of the invention to enter precisely one or more characters of the desired word, as described before, and the system may propose/predict other word(s), accordingly.

FIG. 366 shows as an example, a device having a touch sensitive surface virtually or physically divided into four zones 366001-366004, wherein each zone corresponds to one of the letter keys of the system as described before. According to one embodiment, a tapping action on a zone (e.g. 366002) corresponds to entering an ambiguous letter of that zone, and a gliding action (e.g. 366023, 366028) provided in predefined direction on said surface may correspond to interacting with one of the keys (e.g. respectively, 366013, 366018) of an imaginary second keypad (e.g. 366009) of the invention, for example, for correcting a letter of a word being proposed. As an example, such a keypad may be used for many eye-free applications such as a GPS application.

### Content Search

The data entry system of the invention may be used for searching contents. In many cases the entries in a database such as a content database may include one or more words. The database used by the system may include compound word having at least two words in an entry. The space character between the single words of an entry may be replaced by or considered as, a connecting character. According to one embodiment of the invention, when a user enters a keyword including two or more words for example into a corresponding field of a search engine, the engine and/or system may be designed in such a way to consider at least a portion (e.g. including at least two words) of the keyword as a compound word and may provide a search based on said compound word, anywhere within the entries of the database.

The data entry system of the invention may be used for entering data in general, and searching content such as ordering a movie/video (e.g. video on demand) procedure. The user may use at least the letter keys to enter a keyword. Because the number of entries of a database of any content are generally limited, and an entry generally includes more than one word, then, generally, the system predicts the right entry mostly without requiring correction procedure, although requiring correction procedure may be possible.

As an example, the method just described may use a remote control of a device such as a television (“TV”), having any type of keys such as soft or hard keys. The user may use a number of letter keys such as the four letter keys of a keypad of the invention (e.g. they can be hard or soft keys wherein letters may be arranged on them as shown in FIG. 365A) to enter the input information corresponding to his desired content such as the title of a movie, title of a song, a portion of the script of the movie/song, etc. As an example, the keys of a remote control used as the four letter keys of the invention may be the volume-up, volume-down, channel-up, and channel-down. The system may many times find the right entry/movie before the user completes the input of the all the information (e.g. key presses). In some cases where there may be more than one entry corresponding to user's input, according to one method, the system may show at least some of them on for example at least a three-by-three-key keypad as described throughout this application, or as the items of a list wherein preferably the items having sequential numbers, and the user may select one them by, for example, using/pressing a corresponding key of the numeric keypad (e.g. the telephone-keypad layout keys) off/on the remote control. Preferably, the system may show the selection to the user during the entry of content title/name or other related keywords where there are less than 11 candidates corresponding to the user's input.

According to one embodiment, any of the proposed candidates may be selected by using a speech recognition system. In this case, as an example, the user may either articulate the content or he/she may pronounce its number in the proposed list, etc.

According to one method, an additional key such as a separate key may be used to enter a connector character preferably precisely during providing the input information corresponding to the keyword. In this case, the ambiguous connecting character represented by a letter key (e.g. the key having letters standing on two points) may be removed from said key. As mentioned before, providing a connecting character precisely may significantly augment the prediction accuracy, and many times the system may predict the desired content before ending to enter the whole input information.

According to one embodiment of the invention, a content word database may have several (e.g. sub) directories based on different categories. This way, the number of entries reduces and the accuracy of prediction augments.

According to one embodiment, the content search may use the correction procedure of the invention. Preferably, the telephone-keypad layout keys of the remote control may be used for such purpose. This matter has been described in detail in different patent applications filed by the inventor. In case that the same telephone-keypad layout keys is used for both the correction procedure mode and selecting a proposed content mode, a switching key may be used for switching between these two modes.

According to one embodiment, any of the proposed candidates may be selected by using a speech recognition system. In this case, as an example, the user may either say the content or he may say its number in the proposed list, etc.

It must be noted, that the remote control device may be of any kind, such as that of a TV, or of any other device/system. It may also either be a remote device exclusively dedicated to TV, or a home control remote control. According to another embodiment, the remote control, may be in form of a software integrated/used-by a device which main functionality is other than computing such as a mobile phone, a smartphone, a tablet, etc.

It must also be noted that the content search using a remote control may not be limited to searching a content but also being applied to any other task such as searching a channel by entering its channel name/appellation (e.g. for example by entering “CNN”). The TV may then change the channel to the one that user has (e.g. just) entered.

### Social Entertainment

The data entry system of the invention trees the screen from the input interface and the user may have the full screen available to see the output. Many applications may be created using the data entry system and/or principle of the invention (e.g. in the advanced/invisible mode wherein no keys appears on the screen). As an example, a chat/texting program may be created wherein two or more users may communicate with each other through their respective (e.g. mobile/fixed) devices and simultaneously see the image (e.g. picture, video/video stream, data stream, etc.) of each other or other selected images such as a TV program on their screens. By using the data entry system of the invention wherein preferably no keys are shown on the screen, the user may type on the screen while seeing the other person's images on the screen and simultaneously typing. The other person may be the person with whom he/she is chatting and may also see the text that said other person types. Preferably, in case said two persons are natives of two different languages, a translation program may be used to simultaneously translate the user's text being entered into the language of the receiving person.

According to one embodiment of the invention, two or more parties can (e.g. simultaneously) videochat between themselves. A user interface may be created for such a purpose on the screen of each party, wherein while a first party/person videochats with a second party/person, he can see the second person's text sent to said first person along with a picture/video of said second person or of another image/video filmed and being send during chat by said second person to said first person, and vise versa. According to one method, the chat and the corresponding picture/video may be sent to all of the parties, preferably simultaneously. According to one method, the history of the chat may be shown on the screen.

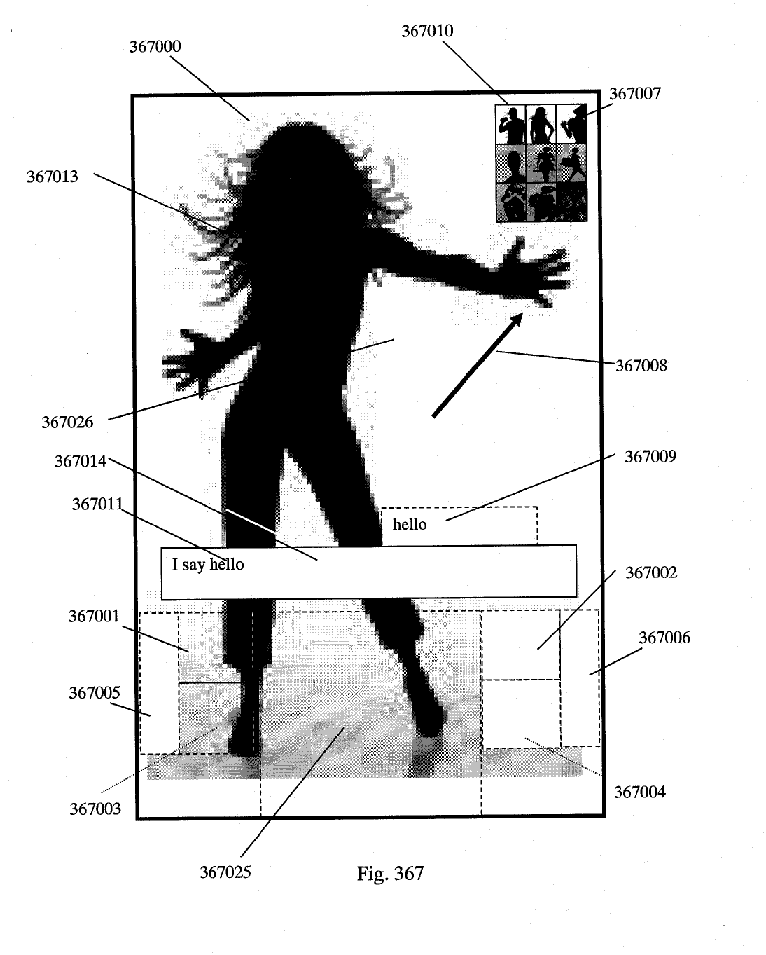

FIG. 367 shows, as an example, the screen 367000 of a device during a videochat using the data entry system of the invention. The system includes the first and second keypad of the invention. In this example, the first keypad of the invention has four letter keys 367001-367004, a space key 367006, and a backspace key 367005. They may be visible, or they may be invisible (dynamic) keys as described before such that they do not occupy the screen. When the first party types a word, the current word 367009 and/or the text 367011 may be shown on said first user's screen (and eventually, in real time on the screen of the second party). The picture and/or the video of the second party with which the first party is videochatting or a picture or video being selected and/or provided/played 367013 by said second party may preferably simultaneously be shown on all of or at least a portion of the screen. A text/chat zone 367014 may be dedicated on the screen 367000 wherein the text of one or preferably all of the parties may be displayed on it. The screen may also include a (small) zone 367010 showing the small pictures/videos of, or the pictures/videos provided, by each of the chatting parties, preferably, the current chatting parties. The pictures/videos may be displayed on at least some of an at least three-by-three matrix zones of static or dynamic images. According to one method, when a first party touches a predefined zone on the screen covering at least a portion of the screen, said first party may provide a gliding/tapping action 367008 resembling that of the correction procedure as described, to select a corresponding picture 367007 identifying a second party with whom to videochat/text. The system then enters into a videochat instance (i.e. state) between the two parties, and preferably displays the enlarged picture/video provided by the second party on the screen of the first party and vice versa, and preferably, replacing that of a previous party. Preferably, when a party touches said predefined zone on the screen, the system provides said small zone 367010 and its corresponding videos/pictures under the party's finger as was described for the second keypad of the invention during the correction procedure.

It must be noted, that a picture/video of the second party may be a live/non-live video of the second party, filmed by said second party while chatting/texting, or it may be some other contents that may be sourced from other sources such as a TV program seen preferably at the same time by parties, etc. Said contents may be such as graphical videos/pictures, or other images. As an example, the TV program may be a sport match wherein parties watching the match may text-chat between each other about the match and about other subjects.

According to one method, the zone used to provide tapping/gliding actions on the screen and/or corresponding to interacting with the text and/or with a keypad of the invention, and the zone to provide interactions such as a gesture for selecting a party may be different zones on the screen.

Note that any of those fields and zones described above, may be placed anywhere on the screen and may be relocated based on the parties' manipulation.

According to one method, a party may simultaneously videochat with more than one other party, and may configure the screen in order to display enlarged pictures/videos of more than one other party on the screen.

### Show all Words, if Available, Completion

According to one embodiment of the invention, during typing a word, in addition to the predicted word/stem, the system may present to the user at least some of the other choices of words corresponding to the input information provided by the user until that moment. According to one method, said other choices may be assigned to/shown on the keys of the second keypad of the invention. Preferably, the system may be designed such that the system may first consider all of the words having the length corresponding to the keys being interacted. If the number of word choices is less than the number of keys of the second keypad or the number of word choices having at least a predefined frequency rate are less than the number of keys of the second keypad, then in addition the system may show some of the words/stems wherein their beginning characters corresponds to the information provided by the user until that moment, for example, based on their priorities (e.g. word completion).

According to one method, the second keypad may have a three-by-three matrix of keys, as described before. According to one method, the word having the next highest priority after the predicted word with the highest priority (which preferably being shown separately as shown throughout this application), may be shown in the center of said second keypad so that a predicted word of the next highest priority may be entered by a tapping action on the screen preferably outside the keys of the first keypad.

According to one method, the second keypad (e.g. including the choices) may be shown automatically, while according to another method, it may be shown at user's request by for example, providing a predefined interaction, such as touching anywhere on the screen outside the keys of the first keypad or providing a gliding action from a key such as the space/backspace key.

According to one embodiment of the invention, if the word predicted is not the desired word, the user may touch anywhere on the screen outside the keys of the first keypad and the system may show, preferably under the user's finger, the other choices of words to the user. If one of the words is the desired word, then, the user then may provide a gliding action towards said word. If none of the other choices is the desired word, the user may remove his finger from the screen and the system may automatically enter into the Precise Character Mode. At this time, the user may begin to enter his word precisely by entering its characters one by one. According to one method, the first precise character entered may replace the first ambiguous character, and the system may propose another word, and so on. If one of the words proposed is the desired word, the user may accept it, but if the words proposed are not the desired word, the user may continue entering all of the remaining characters of his desired word, precisely. According to one method, after the user ends entering his desired word, by providing an end-of-the-word signal such as a space character, the system may automatically enter back to ambiguous/predictive mode.

According to one embodiment, if the user selects one of the proposed words/stems other than the main predicted word/stem, for example by providing an appropriate gliding/tapping action, then the system may propose said selected word/stem as a new main proposed word to the user. According to one method, the system considers all of the letters of the new main word as precise characters, and may show words/sterns beginning with said main proposed word on the keys of the second keypad. At this time, if for example, the user desired to enter the main proposed word, he may provide an end-of the-word signals such as pressing on the space key. On the other hand, if the user desires one of the words/sterns proposed on the new second keypad he may provide a corresponding tapping/gliding action, and so on. Alternatively, if the user does not desire any of the proposed word, he may provide more input information for example by tapping on keys of the first keypad corresponding to at least one of the remaining characters of his desired word.

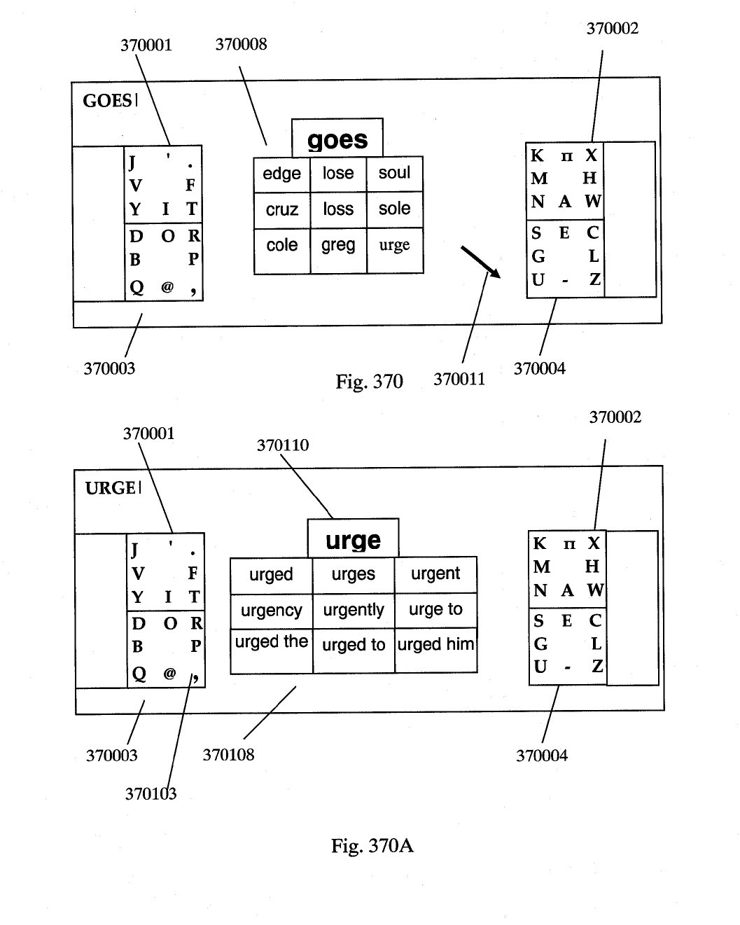

FIG. 370 shows as an example, a predicted word “goes” being proposed by the system based on the input information provided by pressing actions provided by the user on the appropriate keys of the first keypad. In addition to the main predicted word, the system also shows other words corresponding to said input information on a second keypad of the invention 370008. At this time, if the user provides a gliding action 370011 (anywhere on the screen, preferably outside the keys of the first keypad) the system may select the word “urge” and consider it as the main proposed word 370110 as shown in FIG. 370A. The letters of the new main proposed word “urge” 370110 may be considered as precise letters. The system then may show a variety of words (of the word database), for example, based on their priority, beginning with said precise letters on the keys of the second keypad 370108. The user may either enter the main proposed word “urge” by providing for example a space character, or he may select one of the words proposed on the keys of the second keypad. In this case, the same procedure may be repeated for the words beginning with a new selected word, and so on.

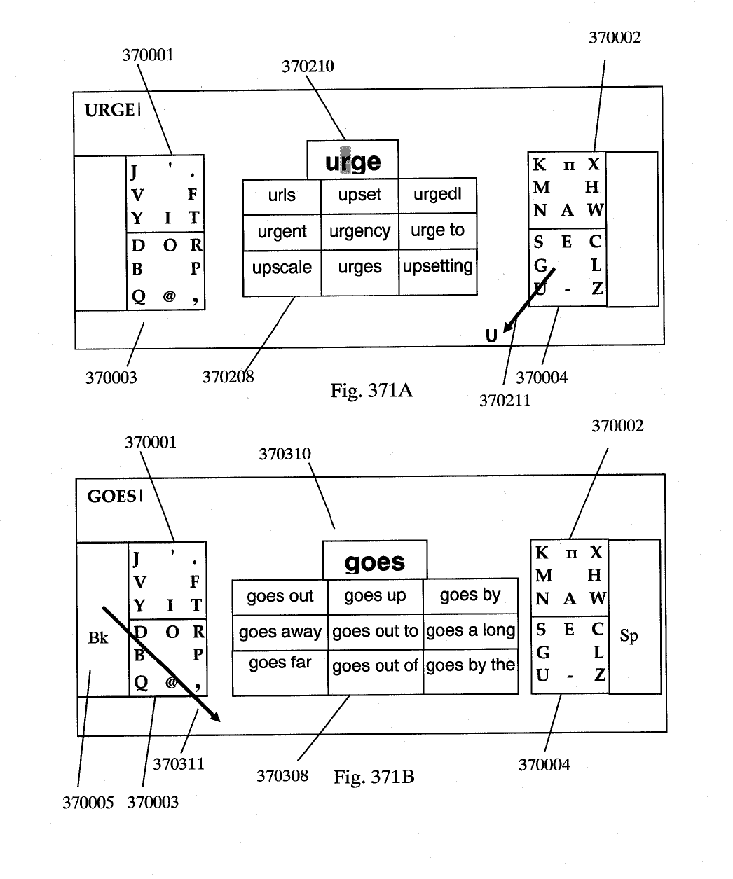

According to one embodiment, by considering the FIG. 370 as an example, after the system proposes the word “goes” and the other words on the second keypad 370008, then as shown in FIG. 371A, if the user proceeds to the correction procedure of the invention by providing precisely the first character “U” of his desired word, for example, by providing the gliding action the 3710211, then the system may predict a word 3710210 corresponding to the input information provided by the user until that moment, and preferably, the system may provide on a second keypad 370208 of the system other words corresponding to said input information (e.g. words beginning with the letter “U” and corresponding to the key presses provided by the user). In this example, one of the proposed words on the second keypad has four letters, and because the database used by the system may not include other words (e.g. with the same number of characters) corresponding to the input information provided by the user, then, the system shows other word(s) being longer than four letters wherein their beginning characters corresponds to the user's input information.

According to another example, after the system proposes the word “goes” and the other words on the second keypad 370008, then as shown in FIG. 371B, if the user desires to provide a word beginning with a proposed word in this example the word “goes”, then he may changes the status of all of the letters of the predicted word to precise, by for example using the function “Lock Word” as described earlier, by for example providing an appropriate gliding action 370311 from the key 370005. At this time, the system may show word beginning with said precise letters “goes”, on the keys of the second keypad 370308. The user now, may either select one of said word(s), or he may provide more input information for example by tapping on keys of the first keypad corresponding to at least one of the remaining characters of his desired word.

According to one method, if the user selects one of the words having more characters than the number of characters corresponding to the input information, then, providing a backspace may bring back the system to the word previously being shown as the main predicted word.

The embodiments above describe methods of word completon which may be also shown for stems being entered precisely through the precise mode instance of the invention.

According to one method, at any stage, if there are not enough words/stems to be proposed on the keys of the second keypad, then the system may propose some auto-corrected words on the keys not being occupied by the proposed words/stems.

### Write by Shape

According to one embodiment of the invention, instead of or in addition to using a key to provide an input signal corresponding to a group of characters, the user may draw a/the shape of/representing (e.g. the common characteristic/shape) said group for example (e.g. anywhere) on a for example, touch sensitive surface such as a touch screen. According to another method, touching the surface with one finger (e.g. one touching point) may represent pressing the key corresponding to the letters standing on one point. Accordingly, touching the surface with two finger (e.g. two touching points) may represent pressing the key corresponding to the letters standing on two points, and so on.

According to another method, forming/providing gestures corresponding/resembling-to the common shape characteristic of each with the singer(s) in the air, may imitate corresponding key interactions.

Said groups of letters divided based on their common shape characteristics as described above may be of any number of groups such as four groups respectively being based on kind of different predefined number of common characteristics such as a common shape characteristic, sound of the letters, etc., as described before, and may be used by a word predictive system for example that of the data entry system of the invention to predict a word.

### Round-Shaped Keys

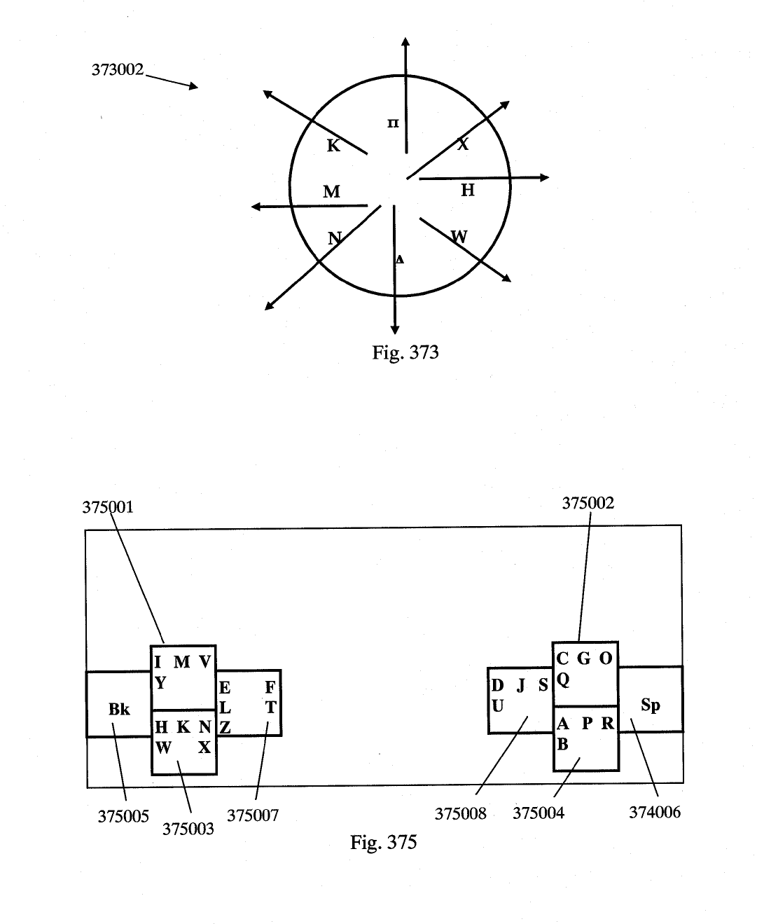

It must be noted, that although through this application, the exemplary second keypad (e.g. and a corresponding keypad model) of the invention is described as having a three-by-three matrix of keys/zones, and gliding actions from the center of said keypad in different predefined directions (e.g. 8 directions) are described to correspond to interacting with the keys of said keypad, obviously, said keypad may have other key/zone arrangements for providing the same/similar gliding actions. For example, FIG. 373, shows an instance 373002 (e.g. corresponding to a key of the first keypad grouping the letter keys that stand on two points) of a round-shaped second keypad of the invention, wherein gliding actions in eight directions may be similar to those used with a keypad having a three-by-three matrix of keys.

### Other Number of Groups/Keys

The number of the letter keys of the first keypad may vary. The number groups of characters divided based on their common shape characteristic may also vary. As an example, FIG. 375 shows an arrangement of the keys of the (e.g. first) keypad of the invention having six keys. Having more letter keys can augment the accuracy of the system and may be beneficial for entering text in languages having large number of letters/symbols (e.g. Hindi) and/or languages having many short words such as those not including vowels in the written text (e.g. Arabic). In the example of 375, the letters of Roman alphabet are distributed on six keys based on their common shape characteristics. Letters having a closed zone on the upper side of their shape are assigned to key 375004, letters having a horizontal line in their shape are assigned to key 375007, letters having circled shape (i.e. substantially circular shape) are assigned to key 375002, letters standing on one point are assigned to key 375001, Letters standing on two points are assigned to key 375003, and letters standing on a curved base are assigned to key 375008.

### General

It must be noted that throughout this application, the terms such as “interacting with the first keypad in the precise mode” or interacting with the first keypad to enter a precise character”, etc., may have been used. It must be noted that such terms are used for entering precise characters using the first keypad of the invention in its corresponding precise mode. In said corresponding precise mode, each of the keys of the keypad may be replaced by a another keypad/having different appearance. Optionally, the second keypad may have the same appearance as the first keypad, which in this application is referred to as the ‘second keypad”. According to one method, a key of a first keypad in the Precise Mode may be divided into a plurality of zone/keys each corresponding to an identified character. In the Precise Mode the plurality of divided zones/keys of the first keypad may be considered to form a corresponding second keypad. Therefore, tapping on a zone of the first keypad may be considered as tapping on the corresponding key of the corresponding second keypad.

### Special Char/Function

It must be noted that in some embodiments the term “special characters” may be considered to refer to special characters and/or functions.

The keys of the first keypad such as the split keypad of the of system may be located on a single surface or they may be distributed on more than one separate surfaces.

A keypad of the invention may be positioned on a pop-up surface (or programmatic pop-up graphic and input mechanism) on the screen of a device. Accordingly, each of the portions of a split keypad may be positioned on a different pop-up. Said pop-up surfaces (or programmatic pop-up graphic and input mechanisms) may preferably have substantially the size of the keypad or its portions, respectively.

In the embodiments and examples described throughout this application, a first group of symbols (e.g. letters) to a key of the first keypad has been described to be selected by a first predefined type of interaction with a key (e.g. taping, double-taping, gliding on or from said key (if on screen key), press and holding, taping on said key and touching a zone of the screen outside said key, etc.) of the first keypad. Then, said selected symbols had been assigned to the keys of a second keypad of the invention. One of said symbols could be entered by a predefined interaction with (the appropriate key of) the second keypad. The same procedure was described for a second group of symbols (e.g. special characters such as digits 0-9) assigned to said key of the first keypad, wherein said second group of symbols could be selected by a second predefined type of interaction with a key of the first keypad, and one of said symbols could be entered as described foe the entry of the symbol of the first group as just described. Clearly, the examples of the embodiments have been provided to describe the procedure of the entry of a symbol through the data entry systems of the invention. It is understood that the order of the assignment of said groups of symbols to the key of the first keypad may be reversed (e.g. the digits group being selected by said first type of interaction, said letters group being selected by said second type of interaction) by people skilled in the art. Note that in all of the embodiments, the type of interaction described is exemplary and may be replaced by any other type of interaction such as those described known by people skilled in the art. For example, a press-and-holding action on a first key for at least a predefined of time to enter said key into a mode instance may be replaced an interaction such as pressing a second key and simultaneously interacting with said first key.

Additionally, many types of interactions with a key (of the first keypad) for assigning a different group of characters to each of them may be considered by people skilled in the art. For example, each of, touching a key and preferably touching another key, touching a key and touching a different predefined location on the screen, touching a key and touching any location on the screen, etc, may be considered as a different type of interaction with said key.

Thus, while there have been shown and described and pointed out fundamental novel features of the invention as applied to alternative embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto. It is to be understood that the drawings are not necessarily drawn to scale, but that they are merely conceptual in nature. It must be noted, that any of the systems, features, means, methods, etc., described in this patent application may be used separately or being combined with systems, features, means, methods, etc., of other different embodiments of the invention.

It must be noted that the number of keys, configuration of letters on said keys, key arrangements, type of keys, etc., are being described as examples. They can be designed differently by people skilled in the art by considering the principles of the invention. It must also be noted that a touch sensitive surface may be touchpad, a touch screen, etc.

It must be noted that although during this application there has been described that a user may touch/press on a key such as the center key of a keypad to provide a gliding action, as described in detail before, if the second keypad of the invention is a dynamic keypad, then the user may touch anywhere on the screen/surface or anywhere on a dedicated zone on the screen/surface (e.g. such as the zone not including one or more keys of the first keypad as described in some embodiments), and that touching point may predefined to correspond to the center of said keypad which, preferably, may dynamically form under the touching point or on another location on the screen. The user then may provide the desired corresponding gliding action.

It must be noted that although in some embodiments through this application for describing the principle of the data entry system of the invention, a touch screen has been used as an example, obviously, any type of touch sensitive surface, any other type of surface, any any number of said surfaces on which to which at least a portion on the input interface (e.g. the input keys/zones used by the system) may be considered for the same purpose.

Optionally all of the input interactions described throughout this patent application may be provided in the air. To intercept such interactions different types of detecting means such as camera(s), accelerometer(s), etc., may be user. According to one embodiment, as an example, a first predefined type of gesture(s) using a first predefined number if fingers (e.g. one finger) provided in the air may correspond to a plurality of first input signal, and a second type of predefined gesture(s) using a second number of fingers (e.g. more than one finger) provided in the air may correspond to a plurality of second input signal. As an example, the plurality of the first predefined gestures may be used for entering ambiguous input information corresponding to a word, and the plurality of the second predefined gesture may be used for entering precise/identified characters. This type of interaction may be used with the word predictive data entry system of the invention such as for example, the general data entry of the vertical (e.g. GPG, content search (e.g. relating to TV)) such as those describet throughout this application.

It must be noted that the data entry system preferably in some cases uses more than one interaction with a key and/or zone simultaneously by for example press/glide and holding on/from a first key and pressing/gliding on/from another key/zone. Obviously, if the user desires to use one hand only with the system, then according to one method, the user may first press/glide on/from said first key and remove his finger. Then he may provide said pressing/gliding on/from said another key/zone.

It is noted that, although according the preferred principle/embodiment of the invention a full set of the letters of a language are distributively assigned to few (e.g. four) keys of a first keypad and another same full set of the letters of the same language are distributively assigned to few keys of a second keypad (e.g. to eight keys of a telephone-type) such that any key of said letter keys of said first keypad and any key of said letter keys of said second keypad have at most one common letter, however, minor modifications/variations may be considered/provided to this principle by people skilled in the art. For example, one (or more) of the (e.g. ambiguous) keys of the first keypad and one (e.g. ambiguous) key of the second keypad (e.g. as just mentioned above) (for some reason) may have more than one common character (although this may augment the ambiguity and slow down the recognition capacity of the system requiring more user's input information).

The input system of the embodiments of the present invention may be used with substantially any electronic and/or computerized device, such as cellular phones, GPS devices, remote controls, handheld devices, television settop boxes and music players. This input system is particularly useful for small sized and/or portable devices on which it is inconvenient to place an entire keyboard. In addition, these input devices may be used on appliances not primarily intended for data input, such as washing machines, refrigerators and the like, which conventionally do not include large keyboards.

It is noted in many paragraphs a first and a second keypad have been named to be used with the data entry system of the invention, obviously. The system may instead use a first and a second group of (different) input signals for the same purpose. Said input signals may be provided by any other input means.

It must be noted that although in this patent application “key” and “(predefined) type of interaction with key” has been used to demonstrate different embodiments and methods as described, obviously, any (predefined) input means (e.g. providing a first and a second group of input signals) and any (predefined) type of interaction provided through said input means to provide a (predefined/different) input signal may be used for the same purpose. For example, instead of distributively assigning the set of letters of a language to the keys of a first keypad, said letters may be assigned to a first predefined type of interaction (e.g. single-pressing action on said keys) with each of said keys of said keypad. Also, instead of distributively assigning another set of letters of said language to the keys of a second keypad, said letters may be assigned to a second predefined type of interaction (e.g. double-pressing action, pressing (e.g. and holding) a mode key and single-pressing, etc.) on/with each of said keys of said first keypad. Obviously, based on the principles of the data entry systems of the invention as described above, the distribution/assigrunent of the letters to said first and second type of interaction with said keys may be such that letters assigned to the first type of interaction with any on the keys of said keypad and letters assigned to the second type of interaction with said key of said keypad have at most one common character.

It must be noted that the features such as keypads, key arrangements, number of keys, assignment of a set of characters of a language to each of a first and second set of keys (e.g. or to each of a second and a second type of interactions with one set of keys), type of keys, type of interactions, etc., as described and shown in this patent application are shown as examples to describe different embodiments of the invention. Obviously, other type of such features can be considered by people skilled in the art.

It must be noted that the first and the second keypad of the invention can have any number of keys. For example, in some embodiments, the second keypad is shown to be a telephone-type keypad having nine keys and in some other embodiments it is shown to have twelve keys.

It must be noted that in addition-to or in replacing-of the correction procedure of the invention, the system may include a method to propose to the user words other that the one predicted by the system. For example, if the predicted word is not the desired word, the user may provide a predefined interaction for example on the screen and the system may show a second keypad wherein its keys include the other words (e.g. having less frequently of use) that correspond to the input information provided until that moment by the user for entering a desired word. Then if the user's desired word is one of said proposed word, the user then may for example provide the corresponding gliding action for selecting/entering his desired word. If any of the words proposed by the system is not what the user desires to enter, then, preferably while holding his finger on the screen, the user may touch another location on the screen and the system shows another second keypad with additional corresponding words (e.g. having less frequently use). And so on.

It must be noted that the procedure of entering a symbol of a group of symbols through the second keypad of the invention wherein the number of symbols of said group of symbols are more than the keys of the second keypad by providing multiple touches to provide multiple second keypads of the invention until the second keypad includes the user's desired symbol as described may be used for any symbol. For example it may he used for entering any punctuation mark character even if the number of the characters of the group is more than the keys of the second keypad. by using such procedure the there is no limit to the number of symbols that a each group may include. The same method may also be used for providing words during the word completion procedure. For example after the used enters into the world completion procedure, if he touches the screen the system may show the second keypad of the invention including some of the words beginning with the user's key presses. As an example if the desired word is not on a key of the presented second keypad, then preferably while holding that finger in touching positing on the screen the user may touch with another finger a location on the screen and the system may open another second keypad with more words. The user may repeat this procedure if the system does not show his word on said another second keypad.

As mentioned, according to one method, in embodiments such as the media search and word completion, a gliding action in a direction may correspond to a list of words or elements. If the list of the words/items/stems in a gliding action direction is long, then according to one method, several gliding actions in said direction may be provided wherein each of said gliding actions may correspond/include some of said words/items/stems. The order of said words/items/stems may be based on a predefined principle such as frequency of use or alphabetical order.

According to one embodiment of the invention, one of the groups of symbols assigned to a predefined interaction with a key of the first keypad such as the backspace key may be called MENU to which menu functions such as User Guide, Language, Reset Settings, etc. may be assigned.

It is noted that the first and second groups of keys may include substantially any suitable number of keys which may be hard or soft keys or combinations of hard and soft keys. The keys may be organized in various configurations and the characters and symbols may be assigned to the keys in any suitable manner. The symbols of the system may be grouped in any number of symbol modes based of any (e.g. arbitrary) category. Optionally, the first group of keys has fewer keys than the second group, as mainly the first group of keys are intended to be used in entering text.

The term key is meant to include any device which identifies finger actuations including pressure sensors, thermal sensors, acceleration sensors, optical systems for tracking movements of the finger, finger caps and gloves with sensors. The sweeping gestures of embodiments of the invention including embodiments for dialing telephone numbers may be identified using various touch sensitive surfaces including internal or external touch screens and a mouse pad. Alternatively, sweeping gestures may be identified by an electronic stylus, acceleration sensors and/or other sensors for identifying user finger movements. The sensors may be mounted on a surface, on finger caps, on gloves and/or on any other suitable mount. The keys or touch screen may be included with processor 130 in the same housing or may be included partially or entirely in a separate unit connected through wires or wirelessly (e.g., using Bluetooth or Wi-Fi) to the unit including processor 130.

According to one embodiment of the invention the sweeping gestures may be provided in the air and are detected by suitable sensors such as a camera and/or acceleration sensors.

In some embodiments of the invention, the data entry systems are adapted to provide synthesized voice feedback on the letters or symbols entered and/or the current symbol mode such that the user need not look at the screen while entering data.

While the above description relates to the Latin alphabet, the principles of the invention may be implemented on other alphabets.

The special characters on the second keypad may be assigned mainly to a same key so that the user may easily remember their location. If the second keypad is a standard telephone-type keypad said special characters may be assigned to the key to which the digit “1” is assigned.

The data entry device in accordance with any of the above described embodiments may be included in a mobile phone, a PDA, a computer or any other device.

According to one embodiment of the invention, after the user provides the input information (e.g. key presses) ambiguously corresponding to several words (e.g. of the dictionary of words of the system), the system may show a first selection of at least some of said corresponding words on the screen. According to one method, said first selection of words may be shown on a (e.g. an imaginary) second keypad (model) of the invention such as a three-by-three matrix keypad as described throughout this application wherein, preferably, a key of said second keypad has at most one word of said first selection of words. According to one method, the user may select one of said selected words by interacting with the corresponding key of the second keypad using a method of interaction such as one of the methods described throughout this application (e.g. tapping/gliding, etc.). If the number of the words corresponding to the input information is more than the number of keys of the second keypad and the user's word is not within the keys of the second keypad, then, the user may provide a predefined interaction, such as a long gliding action, etc., and the system may show a second selection of the said corresponding words on the keys of said second keypad, and so on.

According to another embodiment, after the system shows said first selection of at least some of said corresponding words on the (e.g. an imaginary) second keypad (model) of the invention as described above, the user may select one of said words that begins with the first letter of his desired word. If said word is the only word corresponding to the user's input information, or if the user provides an end-of-the-word signal such as a space character, then, the system may consider said word as the user's desired word and enters it. If said word is not the only word corresponding to the user's input information, then, the system selects all of the words corresponding to the user's combined input information (e.g. the words corresponding to said input information and beginning with said first letter) and shows them on the keys of the second keypad. At this time, the user may select one of said words presented on the second keypad if it is for example, his desired word. If his word is not on any of the keys of the second keypad and the system includes more words relating to said combined input information, then, the user may provide a predefined interaction such as a long gliding action, etc., and the system may show another selection of the words corresponding to the combined input information on the keys of said second keypad, and so on.

It must be noted, that a procedure such as a method of the data entry assigned to a first type of interactions with a key of the keypad of the system may be assigned to a second type of interaction with a key, and vise versus. For example, assignment of two different methods of entering a precise character within a word being entered, by relating said precise character to replacing an ambiguous character or inserting/adding it within the word being entered, to two different type of interaction with a letter key, may be reversed between said two types of interaction (e.g. the first type of interaction may be a gliding action provided on/from a letter key relating to a letter on said key, and the second type of interaction may be a tapping action on a letter/letter-zone on said key during the Precise Character Mode Instance.

It must be noted that the examples of interfaces such as a first and second keypads are used to describe the principles of the dat entry system of the invention. It must be noted that other types of interface may be used for the same purpose, for example, when a user rejects a predicted word, instead of or in additions to the second (e.g. precise) keyboard (e.g. the plurality of second keypads of the invention), the system may have available or may enable/present another interface such as a microphone and a speech recognition system so that the user being able to enter for precise characters (e.g. for the correction purpose).

It must be noted that the term “combined predicted word” is used in some embodiment, generally refers to an N-gram Current word.

### CONCLUSION

It will be appreciated that the above described methods may be varied in many ways, including, changing the specific elements used and their layout. It should also be appreciated that the above described description of methods and apparatus are to be interpreted as including apparatus for carrying out the methods and methods of using the apparatus. The present invention has been described using non-limiting detailed descriptions of embodiments thereof that are provided by way of example and are not intended to limit the scope of the invention. Many specific implementation details may be used. The above embodiments may be implemented in hardware, software, firmware or combinations thereof.

It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art. Furthermore, the terms “comprise,” “include,” “have” and their conjugates, shall mean, when used in the claims, “including but not necessarily limited to.”

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims.

The titles used in this application and in the related applications may preferably not been considered as part of the specifications.

It must be noted that all of the interactions such as (key) pressing/tapping actions, gestures, movements, handwritings, drawings, etc., as described throughout this application may be provided in the air. A movement detecting means such as a camera, an accelerometer, etc., may be used to detect and/or perceive/capture those interactions.

Note that the titles in this application may preferably not be considered as part of the specifications.

It must be noted that in some embodiments specific types of interactions such as a first and/or second types of the interaction are being used to describe the embodiment. Obviously, instead of said specifically described interactions any type(s) of other interactions may be used for the same purpose in said some embodiments.

1. A data entry system comprising:
A plurality of input signals to which substantially all of the letters of an alphabet are assigned;
wherein the letters assigned to the input signals are divided in a plurality of groups of letters such that the letters of each of the groups have a similar characteristic in their shapes, and;
wherein the first group substantially includes the letters that have a substantially closed circle in their shape.

2. The system according to claim 1, wherein one of the other groups substantially includes the letters that stand on one point.

3. The system according to claim 1, wherein one of the other groups substantially includes the letters that stand on two points.

4. The system according to claim 1, wherein one of the other groups substantially includes the letters that stand on a wide base.

5. The system according to claim 1, wherein said plurality of groups of letters are four groups of letters.

6. The system according to claim 5, wherein each of said four input signals is provided by a different input means.

7. The system according to claim 5, wherein said input signals are provided by key interactions.

8. The system according to claim 1, wherein in the assignment of letters to the keys, the first group of letters has priority over the other groups.

9. The system according to claim 1, wherein said group includes the letters “B”, “D”, “O”, “P”, “Q”, and “R”.

10. The system according to claim 2, wherein said group includes at least the letters “F”, “I”, “T”, “V” and “Y”.

11. The system according to claim 3, wherein said group includes the leters “A”, “H”, “K”, “M”, “N”, “W”, and “X”.

12. The system according to claim 4, wherein said group includes the letters “C”, “E”, “G”, “L”, “S”, “U”, and “Z”.

13. A word predictive data entry system comprising:
a plurality of input signals to which substantially all of the letters of a language are assigned, such that at least one of said input signals; and
a database of words;
wherein upon providing at least a one input signal the system predicts a first word of the database, and wherein;
if the predicted word is not the desired word, the user provides a predefined interaction rejecting the predicted word, and the system presents an input interface to the user for entering identified characters.

14. The system according to claim 13, wherein upon receiving a precise character the systm predicts another word.

15. The system according to claim 13, wherein the system predicts a second word.

16. The system according to claim 13, wherein the letters assigned to the input signals are divided in a plurality of groups of letters such that the letters of each of the groups have a similar characteristic in their shapes.

17. The system according to claim 16, wherein the first group substantially includes the letters that have a substantially closed circle in their shape.

18. The system according to claim 16, wherein one of the other groups substantially includes the letters that stand on one point.

19. The system according to claim 16, wherein one of the other groups substantially includes the letters that stand on two points.

20. The system according to claim 16, wherein one of the other groups substantially includes the letters that stand on a wide base.

21. The system according to claim 16, wherein the letters are divided into four different groups, wherein the letters of each group have a common characteristic in their shapes.
